(19) United States
(12) Patent Application Publication
(10) Pub. No.: US 2025/0282100 A1
(43) Pub. Date: Sep. 11, 2025

(54) METHOD AND SYSTEM FOR THREE-DIMENSIONAL PRINTING ON FABRIC

(71) Applicant: Stratasys Ltd., Rehovot (IL)

(72) Inventors: Assaf BEN ATTAR, Rehovot (IL); Yoav BRESSLER, Tel-Aviv (IL); Vitali KRASNOPOLSKY, Rishon LeZion (IL); Ofir ASHKENAZY, Mevaseret Zion (IL); Ofir LIPMAN, Ness Ziona (IL); Michael Lars INBAR, Kiryat Tivon (IL); Boris BELOCON, Rehovot (IL); Artur SOLDATENKO, Yad Hana (IL); Tal ULSHECHIK, Rehovot (IL)

(73) Assignee: Stratasys Ltd., Rehovot (IL)

(21) Appl. No.: 18/859,564

(22) PCT Filed: Apr. 24, 2023
(86) PCT No.: PCT/IL2023/050421

§ 371 Date: Oct. 24, 2024

Related U.S. Application Data
(60) Provisional application No. 63/334,155, filed on Apr. 24, 2022.

(51) Int. Cl. B29C 64/393; B33Y 30/00; B33Y 40/00; B33Y 50/02; B41J 3/407

(52) U.S. Cl. CPC B29C 64/393; B41J 3/4078; B33Y 30/00; B33Y 40/00; B33Y 50/02

(57) ABSTRACT

A method of testing adherence level of a substance to a fabric, comprises: printing a stack of layers of the substance on the fabric, and printing a modeling material onto the stack of substance layers to form two gap-separated stacks of modeling material layers. The method also comprises bending the fabric at the gap so as to detach at least one of the stacks of modeling material layers from the fabric at a detachment point bordering the gap.

### RELATED APPLICATION

This application claims the benefit of priority of U.S. Provisional Patent Application No. 63/334,155 filed on Apr. 24, 2022, the contents of which are incorporated herein by reference in their entirety.

### FIELD AND BACKGROUND OF THE INVENTION

The present invention, in some embodiments thereof, relates to three-dimensional printing and, more particularly, but not exclusively, to a method and system for three-dimensional printing on fabric.

Additive manufacturing (AM) is a technology enabling fabrication of shaped structures directly from computer data via additive formation steps. The basic operation of any AM system consists of slicing a three-dimensional computer model into thin cross sections, translating the result into two-dimensional position data and feeding the data to control equipment which fabricates a three-dimensional structure in a layerwise manner.

Additive manufacturing entails many different approaches to the method of fabrication, including three-dimensional (3D) printing such as 3D inkjet printing. 3D inkjet printing is performed by a layer by layer inkjet deposition of building materials. Thus, a building material is dispensed from a dispensing head having a set of nozzles to deposit layers on a supporting structure. The layers are then leveled by a leveling device, and cured or solidified.

Various three-dimensional printing techniques exist and are disclosed in, e.g., U.S. Pat. Nos. 6,259,979, 6,569,373, 6,658,314, 6,850,334, 6,863,859, 7,183,335, 7,209,797, 7,225,045, 7,300,619, 7,500,846, 9,031,680 and 9,227,365, U.S. Published Application No. 20060054039, and International publication Nos. WO2016/009426, and WO2022/024114 all by the same Assignee, and being hereby incorporated by reference in their entirety. For example, International publication No. WO2022/024114 describes a system for three-dimensional printing, which comprises an array of nozzles for dispensing building materials, a work tray, a jig for affixing a fabric to the work tray, and a computerized controller for operating the array of nozzles to dispense a building material on the affixed fabric. An imaging system may be positioned to image a fabric placed on the work tray, and image data received from the imaging system many be processed to identify patterns on the fabric, wherein the nozzles dispense the building material at locations selected relative to the identified features.

### SUMMARY OF THE INVENTION

According to some embodiments of the invention the present invention there is provided a method of testing adherence level of a substance to a fabric. The method comprises: printing a stack of layers of the substance on the fabric; printing a modeling material onto the stack of substance layers to form two gap-separated stacks of modeling material layers, wherein a bending resistance is higher for the stacks of modeling material layers than for each of the stack of substance layers and the fabric; and bending the fabric at the gap so as to detach at least one of the stacks of modeling material layers from the fabric at a detachment point bordering the gap.

According to some embodiments of the invention the method comprises applying a pre-treatment to the fabric prior to the printing of the stack of substance layers.

According to some embodiments of the invention the gap has a piecewise linear shape, and the detachment point is near a breakpoint of the piecewise linear shape.

According to some embodiments of the invention the gap forms an acute angle at the breakpoint.

According to some embodiments of the invention the gap has a curved shape.

According to some embodiments of the invention a width of the gap is less than 1 mm.

According to some embodiments of the invention the gap-separated stacks form a three-dimensional structure having a planar aspect ratio of from about 1:3 to about 1:10.

According to some embodiments of the invention thicknesses of the stacks of modeling material are larger than a thickness of the stack of substance layers.

According to some embodiments of the invention the thicknesses of the stacks of modeling material are at least two times larger than the thickness of the stack of substance layers.

According to some embodiments of the invention a thickness of the stack of substance layers is from about 0.1 mm to about 1 mm.

According to some embodiments of the invention the stacks of layers of the modeling material comprises a multiplicity of through holes defining open cells in the stacks.

According to an aspect of some embodiments of the present invention there is provided a method of three-dimensional printing on a fabric. The method comprises: dispensing a first modeling material to form an adhesive stack of layers on the fabric; dispensing a second modeling material onto the adhesive stack in a configured pattern corresponding to a shape of a three-dimensional object; wherein the modeling materials are curable, and wherein a lateral curing shrinkage is higher for the second modeling material than for the first modeling material.

According to some embodiments of the invention the first modeling material is formed of a single modeling formulation.

According to some embodiments of the invention the first modeling material is a digital modeling material formed of at least two different modeling formulations.

According to some embodiments of the invention the method comprises receiving input pertaining to a selected foldability of the three-dimensional object, and selecting a relative spatial distribution of the different modeling formulations based on the selected foldability.

According to some embodiments of the invention the adhesive stack comprises less than 20 layers.

According to some embodiments of the invention the method comprises, prior to the dispensing of the first modeling material, attaching a first side of a double-sided adhesive sheet to a work tray, and attaching the fabric to an opposite side of the double-sided adhesive sheet.

According to some embodiments of the invention the method comprises, prior to the attachment of the double-sided adhesive sheet to the work tray, dispensing a third modeling material directly onto the work tray, wherein the first side of the double-sided adhesive sheet is attached to the third modeling material.

According to some embodiments of the invention the dispensing the third modeling material, is by dispensing at most five layers of the third modeling material.

According to some embodiments of the invention the method comprises dispensing a coating modeling material on an outermost surface of the second modeling material, wherein a stickiness of the second modeling material is higher than a stickiness of the coating modeling material.

According to some embodiments of the invention the dispensing the coating modeling material is executed exclusively on regions of the outermost surface that are shape-wise and size-wise compatible with a predetermined continuous hull.

According to an aspect of some embodiments of the present invention there is provided a method of three-dimensional printing on a fabric. The method comprises: attaching a first side of a double-sided adhesive sheet to a work tray; attaching the fabric to an opposite side of the double-sided adhesive sheet; and dispensing a modeling material onto the fabric in a configured pattern corresponding to a shape of a three-dimensional object.

According to some embodiments of the invention the method comprises fixating a periphery of the fabric to the work tray by a jig, following the attachment of the fabric to the opposite side of the double-sided adhesive sheet.

According to some embodiments of the invention the method comprises, prior to the attachment of the double-sided adhesive sheet to the work tray, dispensing a modeling material directly onto the work tray, wherein the first side of the double-sided adhesive sheet is attached to the modeling material on the work tray.

According to some embodiments of the invention the dispensing the modeling material directly onto the work tray, is by dispensing at most five layers of the modeling material.

According to some embodiments of the invention the method comprises dispensing a coating modeling material on an outermost surface of the second modeling material, wherein a stickiness of the second modeling material is higher than a stickiness of the coating modeling material.

According to some embodiments of the invention the dispensing the coating modeling material is by dispensing at most three layers of the coating modeling material.

According to some embodiments of the invention the dispensing the coating modeling material is executed exclusively at voxels of the outermost surface that lie on a continuous hull describing the outermost surface, and being characterized by a predetermined elementary size.

According to an aspect of some embodiments of the present invention there is provided a method of processing data for printing of a three-dimensional object. The method comprises: receiving a point cloud describing an outer surface of the object; constructing a continuous hull describing the point cloud using a moving elementary shape having a predetermined elementary size in a manner that no point of the point cloud is within the elementary shape, and identifying points of the point cloud that are on the continuous hull; sampling the point cloud to provide a grid of voxels, and designating a modeling material to at least a portion of the voxels based on the identification; and storing in a memory the grid of voxels and the designations.

According to some embodiments of the invention the elementary shape is a circle and the continuous hull is an alpha-shape.

According to some embodiments of the invention the continuous hull is a curved shape.

According to some embodiments of the invention the method comprises designating a coating modeling material for each voxel that corresponds to an identified point, and a different modeling material to at least a portion of all other voxels, wherein a stickiness of the coating modeling material is less than a stickiness of the different modeling material.

According to some embodiments of the invention the method comprises applying a morphological dilation operation to the grid of voxels, wherein the designating comprises designating for voxels added by the dilation operation and for voxels that correspond to identified points the same modeling material.

According to some embodiments of the invention the method comprises for each at least a portion of the voxels, generating dispensing instructions based on the designation, and dispensing and solidifying a modeling material based on the dispensing instructions to sequentially form a plurality of hardened layers in a configured pattern corresponding to the shape of the three-dimensional object.

According to an aspect of some embodiments of the present invention there is provided a system for printing a three-dimensional object by additive manufacturing. The system comprises: a data processor configured for executing the method as delineated above and optionally and preferably as further detailed below, to provide processed computer object data comprises the grid of voxels and the designations; a plurality of dispensing heads, having a plurality of dispensing nozzles configured for dispensing a plurality of modeling materials; a solidification system configured for solidifying each of the materials; and a computerized controller having a 10 circuit configured for operating the dispensing heads and the solidification system to sequentially dispense and solidify a plurality of layers according to the processed computer object data.

According to an aspect of some embodiments of the present invention there is provided a method of three-dimensional printing. The method comprises: printing a modeling material on a work tray to form a ramp elevated above the work tray; placing on the elevated ramp a garment having a region of uniform thickness and a region of non-uniform thickness, in a manner that the region of uniform thickness is on the ramp, and the region of non-uniform thickness is at a vertical position below the ramp; and printing a three-dimensional object on the region of uniform thickness.

According to some embodiments of the invention the region of non-uniform thickness is selected from the group consisting of a stitch, a seam, a pocket, a zipper, a button, a collar, a hood, a sticker, a waist belt, a fly piece, a knot, a strap, and a fastener.

According to some embodiments of the invention the ramp has a base in contact with the work tray, and an upper platform having a supported portion that is supported by the base and an overhanging portion.

According to some embodiments of the invention the method comprises placing a portion of the garment below the overhanging portion.

According to some embodiments of the invention the garment has a tubular part and wherein the placing comprises pulling the tubular part over the hanging portion of the ramp.

According to an aspect of some embodiments of the present invention there is provided a method of aligning a fabric for three-dimensional printing. The method comprises: fixating a transparent slide to a work tray at a lateral position relative thereto; dispensing a modeling material to form alignment marks onto the slide; removing the slide from the work tray; fixating a periphery of the fabric to the work tray by a jig; fixating the transparent slide on the fabric at the lateral position; and adjusting a lateral position of the fabric based on the alignment marks.

According to an aspect of some embodiments of the present invention there is provided a method of aligning a fabric for three-dimensional printing, the fabric being fixated to a work tray of a printing system. The method comprises: operating an imaging system to generate an image of the fabric, the image being registered with respect to a lateral system-of-coordinates of the printing system; displaying a graphical user interface (GUI) showing the image; and overlaying the image with a graphical representation of the object at a GUI location described by the lateral system-of-coordinates.

According to some embodiments of the invention the method comprises transmitting a command to the printing system to print the object on the fabric at a physical location corresponding to the display location.

According to some embodiments of the invention the method comprises co-registering a system-of-coordinates of the imaging system with the lateral system-of-coordinates of the printing system.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D are schematic illustrations of an additive manufacturing system according to some embodiments of the invention;

FIGS. 2A-2C are schematic illustrations of printing heads according to some embodiments of the present invention;

FIGS. 3A and 3B are schematic illustrations demonstrating coordinate transformations according to some embodiments of the present invention;

FIG. 4 is a flowchart diagram illustrating a method suitable for testing adherence level of a substance to a fabric, according to some embodiments of the present invention;

FIGS. 5A-D are schematic illustrations of a two-part structure suitable for use by the method described in FIG. 4, according to some embodiments of the present invention;

FIG. 6 is a schematic illustration of a procedure for bending the two-part structure, according to some embodiments of the present invention;

FIG. 7 is a flowchart diagram of a method suitable for three-dimensional printing on a fabric, according to some embodiments of the present invention;

FIG. 8 is a schematic illustration showing a three-dimensional object printed on a fabric, according to some embodiments of the present invention;

FIGS. 9A and 9B are schematic illustrations of a jig suitable for fixating a fabric, according to some embodiments of the present invention;

FIG. 10 is a flowchart diagram of a method suitable for processing data for printing of a three-dimensional object, according to some embodiments of the present invention;

FIGS. 11A and 11B are schematic illustrations of a procedure for constructing a continuous hull, according to some embodiments of the present invention;

FIGS. 12A-D are schematic illustrations of a method suitable for printing a three-dimensional object on a garment, according to some embodiments of the present invention;

FIGS. 13A-F are schematic illustrations of a method suitable for aligning a fabric for three-dimensional printing, according to some embodiments of the present invention;

FIGS. 14A and 14B are schematic illustrations of a method suitable for automatically aligning a fabric for three-dimensional printing, according to some embodiments of the present invention; and

FIG. 15 is a graph showing experimental results of an adherence level test performed according to some embodiments of the present invention.

### DESCRIPTION OF SPECIFIC EMBODIMENTS OF THE INVENTION

The present invention, in some embodiments thereof, relates to three-dimensional printing and, more particularly, but not exclusively, to a method and system for three-dimensional printing on fabric.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The method and system of the present embodiments manufacture three-dimensional objects based on computer object data in a layerwise manner by forming a plurality of layers in a configured pattern corresponding to the shape of the objects. The formation of the layers is optionally and preferably by printing, more preferably by inkjet printing. The computer object data can be in any known format, including, without limitation, a Standard Tessellation Language (STL) or a StereoLithography Contour (SLC) format, an OBJ File format (OBJ), a 3D Manufacturing Format (3MF), Virtual Reality Modeling Language (VRML), Additive Manufacturing File (AMF) format, Drawing Exchange Format (DXF), Polygon File Format (PLY) or any other format suitable for Computer-Aided Design (CAD).

The computer object data can be a data structure including a plurality of graphic elements (e.g., a mesh of polygons, non-uniform rational basis splines, etc.). Typically, the graphic elements are transformed to a grid of voxels defining the shape of the object, for example, using a slicing procedure that form a plurality of slices, each comprising a plurality of voxels describing a layer of the 3D object.

Since the grid of voxels and the plurality of graphic elements describe the same object, the term “computer object data” is used herein both in relation to the grid of voxels and in relation to the plurality of graphic elements. Thus, when the computer object data relate to the grid of voxels, each element of the computer object data is a voxel, and when the computer object data relate to the graphic elements each element of the computer object data is a graphic element, e.g., a polygon, a spline, etc.

The term “object” as used herein refers to a whole three-dimensional object or a part thereof.

Each layer can be formed by an AM apparatus which scans a two-dimensional surface and patterns it. While scanning, the apparatus visits a plurality of target locations on the two-dimensional layer or surface, and decides, for each target location or a group of target locations, whether or not the target location or group of target locations is to be occupied by building material formulation, and which type of building material formulation is to be delivered thereto. The decision is made according to a computer image of the surface.

In preferred embodiments of the present invention the AM comprises three-dimensional printing, more preferably three-dimensional inkjet printing. In these embodiments a building material is dispensed from a printing head having one or more arrays of nozzles to deposit building material in layers on a supporting structure. The AM apparatus thus dispenses building material in target locations which are to be occupied and leaves other target locations void. The apparatus typically includes a plurality of arrays of nozzles, each of which can be configured to dispense a different building material. This is typically achieved by providing the printing head with a plurality of fluid channels separated from each other, wherein each channel receives a different building material through a separate inlet and conveys it to a different array of nozzles.

Thus, different target locations can be occupied by different building material formulations. The types of building material formulations can be categorized into two major categories: modeling material formulation and support material formulation. The support material formulation serves as a supporting matrix or construction for supporting the object or object parts during the fabrication process and/or other purposes, e.g., providing hollow or porous objects. Support constructions may additionally include modeling material formulation elements, e.g. for further support strength.

The modeling material formulation is generally a composition which is formulated for use in additive manufacturing and which is able to form a three-dimensional object on its own, i.e., without having to be mixed or combined with any other substance.

The final three-dimensional object is made of the modeling material formulation or a combination of modeling material formulations or modeling and support material formulations or modification thereof (e.g., following curing). All these operations are well-known to those skilled in the art of solid freeform fabrication.

In some exemplary embodiments of the invention an object is manufactured by dispensing two or more different modeling material formulations, each material formulation from a different array of nozzles (belonging to the same or different printing heads) of the AM apparatus. In some embodiments, two or more such arrays of nozzles that dispense different modeling material formulations are both located in the same printing head of the AM apparatus. In some embodiments, arrays of nozzles that dispense different modeling material formulations are located in separate printing heads, for example, a first array of nozzles dispensing a first modeling material formulation is located in a first printing head, and a second array of nozzles dispensing a second modeling material formulation is located in a second printing head.

In some embodiments, an array of nozzles that dispense a modeling material formulation and an array of nozzles that dispense a support material formulation are both located in the same printing head. In some embodiments, an array of nozzles that dispense a modeling material formulation and an array of nozzles that dispense a support material formulation are located in separate printing heads.

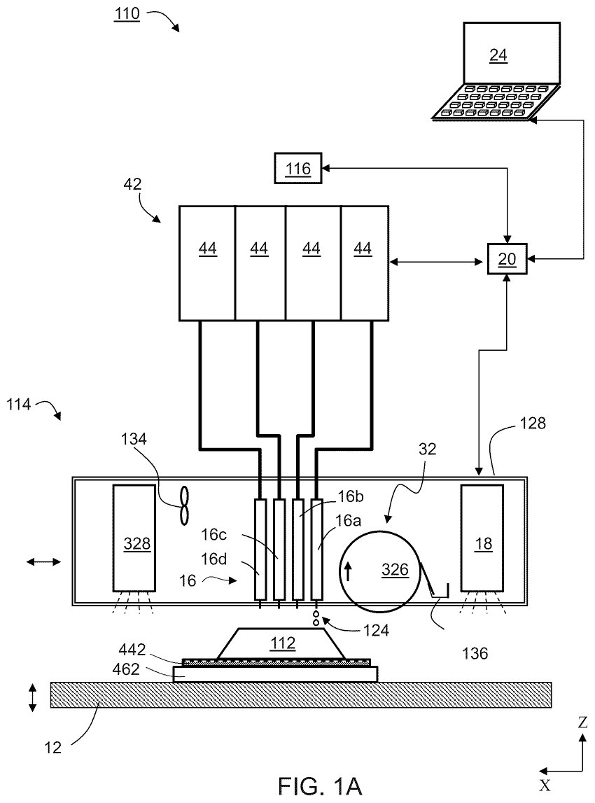

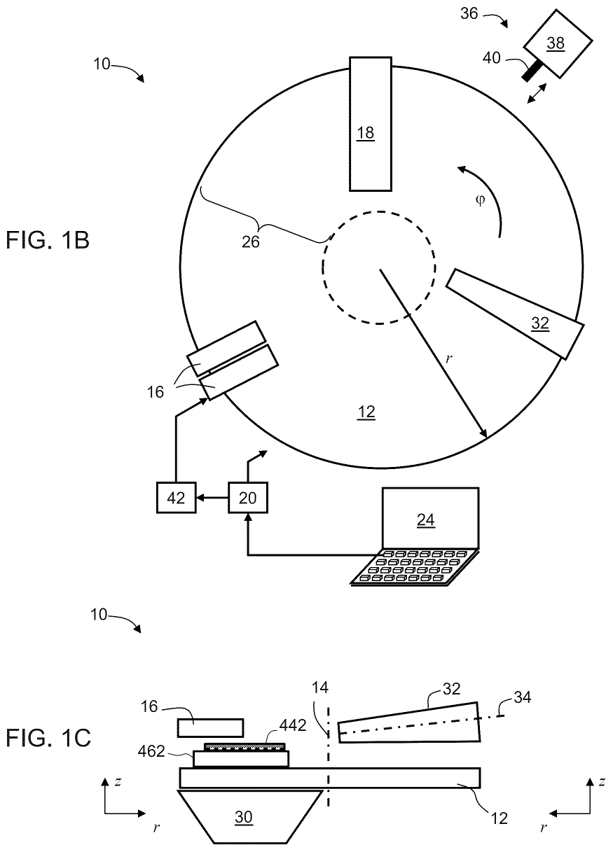

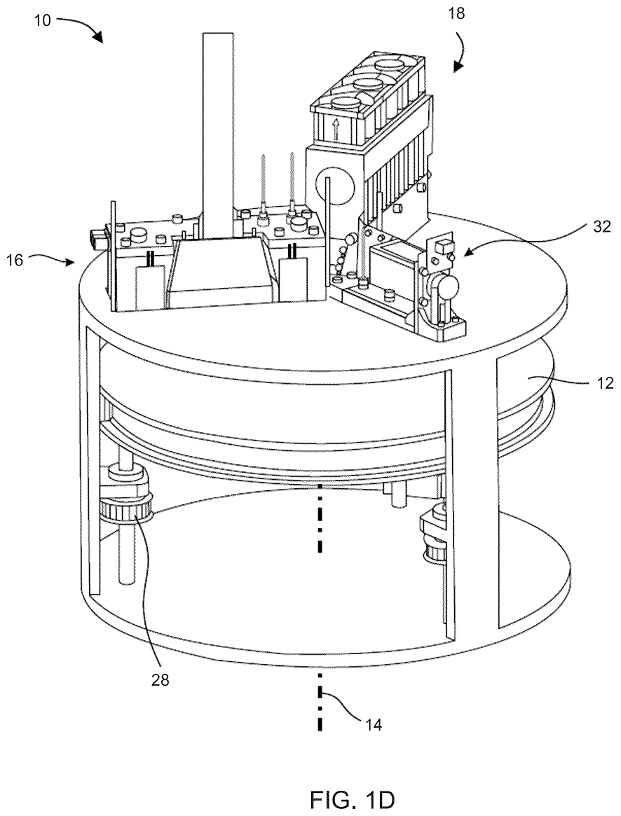

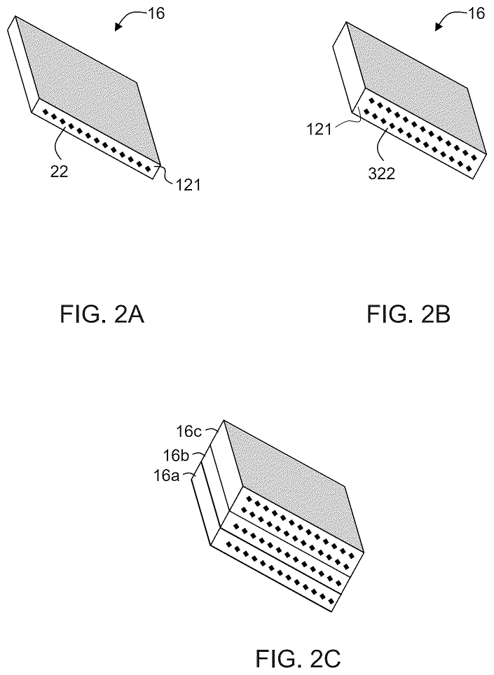

A representative and non-limiting example of a system 110 suitable for AM of an object 112 according to some embodiments of the present invention is illustrated in FIG. 1A. System 110 comprises an additive manufacturing apparatus 114 having a dispensing unit 16 which comprises a plurality of printing heads. Each head preferably comprises one or more arrays of nozzles 122, typically mounted on an orifice plate 121, as illustrated in FIGS. 2A-C described below, through which a liquid building material formulation 124 is dispensed.

Preferably, but not obligatorily, apparatus 114 is a three-dimensional printing apparatus, in which case the printing heads are printing heads, and the building material formulation is dispensed via inkjet technology. This need not necessarily be the case, since, for some applications, it may not be necessary for the additive manufacturing apparatus to employ three-dimensional printing techniques. Representative examples of additive manufacturing apparatus contemplated according to various exemplary embodiments of the present invention include, without limitation, fused deposition modeling apparatus and fused material formulation deposition apparatus.

Each printing head is optionally and preferably fed via one or more building material formulation reservoirs which may optionally include a temperature control unit (e.g., a temperature sensor and/or a heating device), and a material formulation level sensor. To dispense the building material formulation, a voltage signal is applied to the printing heads to selectively deposit droplets of material formulation via the printing head nozzles, for example, as in piezoelectric inkjet printing technology. Another example includes thermal inkjet printing heads. In these types of heads, there are heater elements in thermal contact with the building material formulation, for heating the building material formulation to form gas bubbles therein, upon activation of the heater elements by a voltage signal. The gas bubbles generate pressures in the building material formulation, causing droplets of building material formulation to be ejected through the nozzles. Piezoelectric and thermal printing heads are known to those skilled in the art of solid freeform fabrication. For any types of inkjet printing heads, the dispensing rate of the head depends on the number of nozzles, the type of nozzles and the applied voltage signal rate (frequency).

Optionally, the overall number of dispensing nozzles or nozzle arrays is selected such that half of the dispensing nozzles are designated to dispense support material formulation and half of the dispensing nozzles are designated to dispense modeling material formulation, i.e. the number of nozzles jetting modeling material formulations is the same as the number of nozzles jetting support material formulation. In the representative example of FIG. 1A, four printing heads 16a, 16b, 16c and 16d are illustrated. Each of heads 16a, 16b, 16c and 16d has a nozzle array. In this Example, heads 16a and 16b can be designated for modeling material formulation/s and heads 16c and 16d can be designated for support material formulation. Thus, head 16a can dispense one modeling material formulation, head 16b can dispense another modeling material formulation and heads 16c and 16d can both dispense support material formulation. In an alternative embodiment, heads 16c and 16d, for example, may be combined in a single head having two nozzle arrays for depositing support material formulation. In a further alternative embodiment any one or more of the printing heads may have more than one nozzle arrays for depositing more than one material formulation, e.g. two nozzle arrays for depositing two different modeling material formulations or a modeling material formulation and a support material formulation, each formulation via a different array or number of nozzles.

Yet it is to be understood that it is not intended to limit the scope of the present invention and that the number of modeling material formulation printing heads (modeling heads) and the number of support material formulation printing heads (support heads) may differ. In some embodiments, the number of arrays of nozzles that dispense modeling material formulation, the number of arrays of nozzles that dispense support material formulation, and the number of nozzles in each respective array are selected such as to provide a predetermined ratio, a, between the maximal dispensing rate of the support material formulation and the maximal dispensing rate of modeling material formulation. The value of the predetermined ratio, a, is preferably selected to ensure that in each formed layer, the height of modeling material formulation equals the height of support material formulation. Typical values for a are from about 0.6 to about 1.5.

As used herein throughout the term “about” refers to ±10%.

For example, for a=1, the overall dispensing rate of support material formulation is generally the same as the overall dispensing rate of the modeling material formulation when all the arrays of nozzles operate.

Apparatus 114 can comprise, for example, M modeling heads each having m arrays of p nozzles, and S support heads each having s arrays of q nozzles such that M×m×p=S×s×q. Each of the M×m modeling arrays and S×s support arrays can be manufactured as a separate physical unit, which can be assembled and disassembled from the group of arrays. In this embodiment, each such array optionally and preferably comprises a temperature control unit and a material formulation level sensor of its own, and receives an individually controlled voltage for its operation.

Apparatus 114 can further comprise a solidifying device 18 which can include any device configured to emit light, heat or the like that may cause the deposited material formulation to harden. For example, solidifying device 18 can comprise one or more radiation sources, which can be, for example, an ultraviolet or visible or infrared lamp, or other sources of electromagnetic radiation, or electron beam source, depending on the modeling material formulation being used. In some embodiments of the present invention, solidifying device 18 serves for curing or solidifying the modeling material formulation.

In addition to solidifying device 18, apparatus 114 optionally and preferably comprises an additional radiation source 328 for solvent evaporation. Radiation source 328 optionally and preferably generates infrared radiation. In various exemplary embodiments of the invention solidifying device 18 comprises a radiation source generating ultraviolet radiation, and radiation source 328 generates infrared radiation.

In some embodiments of the present invention apparatus 114 comprises cooling system 134 such as one or more fans or the like.

The printing head(s) and radiation source are preferably mounted in a frame or block 128 which is preferably operative to reciprocally move over a tray 12, which serves as the working surface. In some embodiments of the present invention the radiation sources are mounted in the block such that they follow in the wake of the printing heads to at least partially cure or solidify the material formulations just dispensed by the printing heads. Tray 12 is positioned horizontally. According to the common conventions an X-Y-Z Cartesian coordinate system is selected such that the X-Y plane is parallel to tray 12. Tray 12 is preferably configured to move vertically (along the Z direction), typically downward. In various exemplary embodiments of the invention, apparatus 114 further comprises one or more leveling devices 32, e.g. a roller 326. Leveling device 326 serves to straighten, level and/or establish a thickness of the newly formed layer prior to the formation of the successive layer thereon. Leveling device 32 preferably comprises a waste collection device 136 for collecting the excess material formulation generated during leveling. Waste collection device 136 may comprise any mechanism that delivers the material formulation to a waste tank or waste cartridge.

In use, the printing heads of unit 16 move in a scanning direction, which is referred to herein as the X direction, and selectively dispense building material formulation in a predetermined configuration in the course of their passage over tray 12. The building material formulation typically comprises one or more types of support material formulation and one or more types of modeling material formulation. The passage of the printing heads of unit 16 is followed by the curing of the modeling material formulation(s) by radiation source 18. In the reverse passage of the heads, back to their starting point for the layer just deposited, an additional dispensing of building material formulation may be carried out, according to predetermined configuration. In the forward and/or reverse passages of the printing heads, the layer thus formed may be straightened by leveling device 32, which preferably follows the path of the printing heads in their forward and/or reverse movement. Once the printing heads return to their starting point along the X direction, they may move to another position along an indexing direction, referred to herein as the Y direction, and continue to build the same layer by reciprocal movement along the X direction. Alternately, the printing heads may move in the Y direction between forward and reverse movements or after more than one forward-reverse movement. The series of scans performed by the printing heads to complete a single layer is referred to herein as a single scan cycle.

Once the layer is completed, tray 12 is lowered in the Z direction to a predetermined Z level, according to the desired thickness of the layer subsequently to be printed. The procedure is repeated to form three-dimensional object 112 in a layerwise manner.

In another embodiment, tray 12 may be displaced in the Z direction between forward and reverse passages of the printing head of unit 16, within the layer. Such Z displacement is carried out in order to cause contact of the leveling device with the surface in one direction and prevent contact in the other direction.

The present embodiments contemplate use of a liquid material formulation supply system 42, which comprises one or more liquid material containers or cartridges 44, and which supplies the liquid material(s) to printing heads. Supply system 42 can be used in an AM system such as system 110, in which case the liquid material in each container is a building material.

A controller 20 controls fabrication apparatus 114 and optionally and preferably also supply system 42. Controller 20 typically includes an electronic circuit configured to perform the controlling operations. Controller 20 preferably communicates with a data processor 24 which transmits digital data pertaining to fabrication instructions based on computer object data, e.g., a CAD configuration represented on a computer readable medium in a form of a Standard Tessellation Language (STL) format or the like. Typically, controller 20 controls the voltage applied to each printing head or each nozzle array and the temperature of the building material formulation in the respective printing head or respective nozzle array.

Once the manufacturing data is loaded to controller 20 it can operate without user intervention. In some embodiments, controller 20 receives additional input from the operator, e.g., using data processor 24 or using a user interface 116 communicating with controller 20. User interface 116 can be of any type known in the art, such as, but not limited to, a keyboard, a touch screen and the like. For example, controller 20 can receive, as additional input, one or more building material formulation types and/or attributes, such as, but not limited to, color, characteristic distortion and/or transition temperature, viscosity, electrical property, magnetic property. Other attributes and groups of attributes are also contemplated.

Another representative and non-limiting example of a system 10 suitable for AM of an object according to some embodiments of the present invention is illustrated in FIGS. 1B-D. FIGS. 1B-D illustrate a top view (FIG. 1B), a side view (FIG. 1C) and an isometric view (FIG. 1D) of system 10.

In the present embodiments, system 10 comprises a tray 12 and a plurality of inkjet printing heads 16, each having one or more arrays of nozzles with respective one or more pluralities of separated nozzles. The material used for the three-dimensional printing is supplied to heads 16 by building material supply system 42, with one or more liquid material containers or cartridges (not shown), as further detailed hereinabove. Tray 12 can have a shape of a disk or it can be annular. Non-round shapes are also contemplated, provided they can be rotated about a vertical axis.

Tray 12 and heads 16 are optionally and preferably mounted such as to allow a relative rotary motion between tray 12 and heads 16. This can be achieved by (i) configuring tray 12 to rotate about a vertical axis 14 relative to heads 16, (ii) configuring heads 16 to rotate about vertical axis 14 relative to tray 12, or (iii) configuring both tray 12 and heads 16 to rotate about vertical axis 14 but at different rotation velocities (e.g., rotation at opposite direction). While some embodiments of system 10 are described below with a particular emphasis to configuration (i) wherein the tray is a rotary tray that is configured to rotate about vertical axis 14 relative to heads 16, it is to be understood that the present application contemplates also configurations (ii) and (iii) for system 10. Any one of the embodiments of system 10 described herein can be adjusted to be applicable to any of configurations (ii) and (iii), and one of ordinary skills in the art, provided with the details described herein, would know how to make such adjustment.

In the following description, a direction parallel to tray 12 and pointing outwardly from axis 14 is referred to as the radial direction r, a direction parallel to tray 12 and perpendicular to the radial direction r is referred to herein as the azimuthal direction φ, and a direction perpendicular to tray 12 is referred to herein is the vertical direction z.

The radial direction r in system 10 enacts the indexing direction y in system 110, and the azimuthal direction φ enacts the scanning direction x in system 110. Therefore, the radial direction is interchangeably referred to herein as the indexing direction, and the azimuthal direction is interchangeably referred to herein as the scanning direction.

The term “radial position,” as used herein, refers to a position on or above tray 12 at a specific distance from axis 14. When the term is used in connection to a printing head, the term refers to a position of the head which is at specific distance from axis 14. When the term is used in connection to a point on tray 12, the term corresponds to any point that belongs to a locus of points that is a circle whose radius is the specific distance from axis 14 and whose center is at axis 14.

The term “azimuthal position,” as used herein, refers to a position on or above tray 12 at a specific azimuthal angle relative to a predetermined reference point. Thus, radial position refers to any point that belongs to a locus of points that is a straight line forming the specific azimuthal angle relative to the reference point.

The term “vertical position,” as used herein, refers to a position over a plane that intersect the vertical axis 14 at a specific point.

Tray 12 serves as a building platform for three-dimensional printing. The working area on which one or objects are printed is typically, but not necessarily, smaller than the total area of tray 12. In some embodiments of the present invention the working area is annular. The working area is shown at 26. In some embodiments of the present invention tray 12 rotates continuously in the same direction throughout the formation of object, and in some embodiments of the present invention tray reverses the direction of rotation at least once (e.g., in an oscillatory manner) during the formation of the object. Tray 12 is optionally and preferably removable. Removing tray 12 can be for maintenance of system 10, or, if desired, for replacing the tray before printing a new object. In some embodiments of the present invention system 10 is provided with one or more different replacement trays (e.g., a kit of replacement trays), wherein two or more trays are designated for different types of objects (e.g., different weights) different operation modes (e.g., different rotation speeds), etc. The replacement of tray 12 can be manual or automatic, as desired. When automatic replacement is employed, system 10 comprises a tray replacement device 36 configured for removing tray 12 from its position below heads 16 and replacing it by a replacement tray (not shown). In the representative illustration of FIG. 1B tray replacement device 36 is illustrated as a drive 38 with a movable arm 40 configured to pull tray 12, but other types of tray replacement devices are also contemplated.

Exemplified embodiments for the printing head 16 are illustrated in FIGS. 2A-2C. These embodiments can be employed for any of the AM systems described above, including, without limitation, system 110 and system 10.

FIGS. 2A-B illustrate a printing head 16 with one (FIG. 2A) and two (FIG. 2B) nozzle arrays 22. The nozzles in the array are preferably aligned linearly, along a straight line. Printing head 16 is fed by a liquid material and dispenses it through the nozzle arrays 22, in response to a voltage signal applied thereto by the controller of the printing system. Head 16 is fed by a liquid material which is a building material formulation.

In embodiments in which a particular printing head has two or more linear nozzle arrays, the nozzle arrays are optionally and preferably can be parallel to each other. When a printing head has two or more arrays of nozzles (e.g., FIG. 2B) all arrays of the head can be fed with the same building material formulation, or at least two arrays of the same head can be fed with different building material formulations.

When a system similar to system 110 is employed, all printing heads 16 are optionally and preferably oriented along the indexing direction with their positions along the scanning direction being offset to one another.

When a system similar to system 10 is employed, all printing heads 16 are optionally and preferably oriented radially (parallel to the radial direction) with their azimuthal positions being offset to one another. Thus, in these embodiments, the nozzle arrays of different printing heads are not parallel to each other but are rather at an angle to each other, which angle being approximately equal to the azimuthal offset between the respective heads. For example, one head can be oriented radially and positioned at azimuthal position φ₁, and another head can be oriented radially and positioned at azimuthal position φ₂. In this example, the azimuthal offset between the two heads is φ₁-φ₂, and the angle between the linear nozzle arrays of the two heads is also φ₁-φ₂.

In some embodiments, two or more printing heads can be assembled to a block of printing heads, in which case the printing heads of the block are typically parallel to each other. A block including several inkjet printing heads 16a, 16b, 16c is illustrated in FIG. 2C.

In some embodiments, system 10 comprises a stabilizing structure 30 positioned below heads 16 such that tray 12 is between stabilizing structure 30 and heads 16. Stabilizing structure 30 may serve for preventing or reducing vibrations of tray 12 that may occur while inkjet printing heads 16 operate. In configurations in which printing heads 16 rotate about axis 14, stabilizing structure 30 preferably also rotates such that stabilizing structure 30 is always directly below heads 16 (with tray 12 between heads 16 and tray 12).

Tray 12 and/or printing heads 16 is optionally and preferably configured to move along the vertical direction z, parallel to vertical axis 14 so as to vary the vertical distance between tray 12 and printing heads 16. In configurations in which the vertical distance is varied by moving tray 12 along the vertical direction, stabilizing structure 30 preferably also moves vertically together with tray 12. In configurations in which the vertical distance is varied by heads 16 along the vertical direction, while maintaining the vertical position of tray 12 fixed, stabilizing structure 30 is also maintained at a fixed vertical position.

The vertical motion can be established by a vertical drive 28. Once a layer is completed, the vertical distance between tray 12 and heads 16 can be increased (e.g., tray 12 is lowered relative to heads 16) by a predetermined vertical step, according to the desired thickness of the layer subsequently to be printed. The procedure is repeated to form a three-dimensional object in a layerwise manner.

The operation of inkjet printing heads 16 and optionally and preferably also of one or more other components of system 10, e.g., the motion of tray 12, are controlled by a controller 20. The controller can have an electronic circuit and a non-volatile memory medium readable by the circuit, wherein the memory medium stores program instructions which, when read by the circuit, cause the circuit to perform control operations as further detailed below.

Controller 20 can also communicate with a host computer 24 which transmits digital data pertaining to fabrication instructions based on computer object data, e.g., in a form of a Standard Tessellation Language (STL) or a StereoLithography Contour (SLC) format, an OBJ File format (OBJ), a 3D Manufacturing Format (3MF), Virtual Reality Modeling Language (VRML), Additive Manufacturing File (AMF) format, Drawing Exchange Format (DXF), Polygon File Format (PLY) or any other format suitable for Computer-Aided Design (CAD). The object data formats are typically structured according to a Cartesian system of coordinates. In these cases, computer 24 preferably executes a procedure for transforming the coordinates of each slice in the computer object data from a Cartesian system of coordinates into a polar system of coordinates. Computer 24 optionally and preferably transmits the fabrication instructions in terms of the transformed system of coordinates. Alternatively, computer 24 can transmit the fabrication instructions in terms of the original system of coordinates as provided by the computer object data, in which case the transformation of coordinates is executed by the circuit of controller 20.

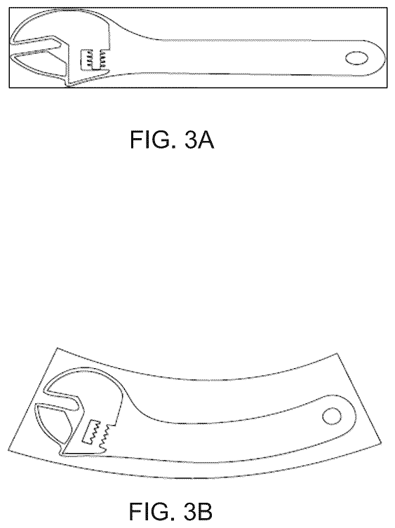

The transformation of coordinates allows three-dimensional printing over a rotating tray. In non-rotary systems with a stationary tray with the printing heads typically reciprocally move above the stationary tray along straight lines. In such systems, the printing resolution is the same at any point over the tray, provided the dispensing rates of the heads are uniform. In system 10, unlike non-rotary systems, not all the nozzles of the head points cover the same distance over tray 12 during at the same time. The transformation of coordinates is optionally and preferably executed so as to ensure equal amounts of excess material formulation at different radial positions. Representative examples of coordinate transformations according to some embodiments of the present invention are provided in FIGS. 3A-B, showing three slices of an object (each slice corresponds to fabrication instructions of a different layer of the objects), where FIG. 3A illustrates a slice in a Cartesian system of coordinates and FIG. 3B illustrates the same slice following an application of a transformation of coordinates procedure to the respective slice.

Typically, controller 20 controls the voltage applied to the respective component of the system 10 based on the fabrication instructions and based on the stored program instructions as described below.

Generally, controller 20 controls printing heads 16 to dispense, during the rotation of tray 12, droplets of building material formulation in layers, such as to print a three-dimensional object on tray 12.

System 10 optionally and preferably comprises one or more solidifying devices 18, such as, but not limited to, radiation sources, which can be, for example, an ultraviolet or visible or infrared lamp, or other sources of electromagnetic radiation, or electron beam source, depending on the modeling material formulation being used. Radiation source can include any type of radiation emitting device, including, without limitation, light emitting diode (LED), digital light processing (DLP) system, resistive lamp and the like. Solidifying devices 18 serves for curing or solidifying the modeling material formulation. In various exemplary embodiments of the invention the operation of solidifying devices 18 is controlled by controller 20 which may activate and deactivate solidifying devices 18 and may optionally also control the amount of radiation generated by solidifying devices 18.

In some embodiments of the invention, system 10 further comprises one or more leveling devices 32 which can be manufactured as a roller or a blade. Leveling device 32 serves to straighten the newly formed layer prior to the formation of the successive layer thereon. In some embodiments, leveling device 32 has the shape of a conical roller positioned such that its symmetry axis 34 is tilted relative to the surface of tray 12 and its surface is parallel to the surface of the tray. This embodiment is illustrated in the side view of system 10 (FIG. 1C).

The conical roller can have the shape of a cone or a conical frustum.

The opening angle of the conical roller is preferably selected such that there is a constant ratio between the radius of the cone at any location along its axis 34 and the distance between that location and axis 14. This embodiment allows roller 32 to efficiently level the layers, since while the roller rotates, any point p on the surface of the roller has a linear velocity which is proportional (e.g., the same) to the linear velocity of the tray at a point vertically beneath point p. In some embodiments, the roller has a shape of a conical frustum having a height h, a radius R₁ at its closest distance from axis 14, and a radius R₂ at its farthest distance from axis 14, wherein the parameters h, R₁ and R₂ satisfy the relation R₁/R₂=(R−h)/h and wherein R is the farthest distance of the roller from axis 14 (for example, R can be the radius of tray 12).

The operation of leveling device 32 is optionally and preferably controlled by controller 20 which may activate and deactivate leveling device 32 and may optionally also control its position along a vertical direction (parallel to axis 14) and/or a radial direction (parallel to tray 12 and pointing toward or away from axis 14.

In some embodiments of the present invention printing heads 16 are configured to reciprocally move relative to tray along the radial direction r. These embodiments are useful when the lengths of the nozzle arrays 22 of heads 16 are shorter than the width along the radial direction of the working area 26 on tray 12. The motion of heads 16 along the radial direction is optionally and preferably controlled by controller 20.

Some embodiments contemplate the fabrication of an object by dispensing different material formulations from different arrays of nozzles (belonging to the same or different printing head). These embodiments provide, inter alia, the ability to select material formulations from a given number of material formulations and define desired combinations of the selected material formulations and their properties. According to the present embodiments, the spatial locations of the deposition of each material formulation with the layer is defined, either to effect occupation of different three-dimensional spatial locations by different material formulations, or to effect occupation of substantially the same three-dimensional location or adjacent to three-dimensional locations by two or more different material formulations so as to allow post deposition spatial combination of the material formulations within the layer, thereby to form a composite material formulation at the respective location or locations.

Any post deposition combination or mix of modeling material formulations is contemplated. For example, once a certain material formulation is dispensed it may preserve its original properties. However, when it is dispensed simultaneously with another modeling material formulation or other dispensed material formulations which are dispensed at the same or nearby locations, a composite material formulation having a different property or properties to the dispensed material formulations may be formed.

In some embodiments of the present invention, for at least one of the layers, the system dispenses two or more formulations to form a digital modeling material.

The phrase “digital modeling material”, as used herein and in the art, describes a combination of two or more materials on a pixel level or voxel level such that pixels or voxels of different material formulations are dispensed in an interlaced manner over a region, and are then hardened (e.g., cured), to form an interlaced pattern of voxels of hardened materials, the interlacing being along multiple directions.

Digital modeling materials may exhibit new properties that are affected by the selection of types of material formulations and/or the ratio and relative spatial distribution of two or more material formulations.

As used herein, a “voxel” of a layer refers to a physical three-dimensional elementary volume within the layer that corresponds to a single pixel of a bitmap describing the layer. The size of a voxel is approximately the size of a region that is formed by a building material, once the building material is dispensed at a location corresponding to the respective pixel, leveled, and solidified.

The present embodiments thus enable the deposition of a broad range of material formulation combinations, and the fabrication of an object which may consist of multiple different combinations of material formulations, in different parts of the object, according to the properties desired to characterize each part of the object.

Further details on the principles and operations of an AM system suitable for the present embodiments are found in U.S. Pat. No. 9,031,680 and International publication No. WO2022/024114, the contents of which are hereby incorporated by reference.

In some embodiments of the present invention system 10 and/or system 110 are configured for printing one or more objects on a fabric.

As used herein “fabric” encompasses any article of manufacture that is made at least partially of a natural or man-made fibrous material. Examples of types of fabric include, but are not limited to: clothes, shoes, toys, fabric articles, carpets, cloth hats, cloth bags, socks, towels, draperies, etc.

The present embodiments contemplate printing on woven or non-woven fabrics.

As used herein, “woven” means a structure produced when at least two sets of strands are interlaced, e.g., at right angles to each other, according to a predetermined pattern of interlacing, and such that at least one set is parallel to the axis along the lengthwise direction of the fabric, in accordance with ASTM D123-03.

As used herein, the term “nonwoven” means a textile structure produced by bonding or interlocking of fibers, or both, accomplished by mechanical, chemical, thermal, or solvent means and combinations in accordance with ASTM D123-03

Preferably, but not necessarily, when the printing system (e.g., system 10 or 110) is employed for printing an object on a fabric, leveling device 32 is not used. In these embodiments, each layer of building material that is dispensed on the fabric is solidified (e.g., cured) after dispensing and without leveling the layer.

Preferably, but not necessarily, when the printing system (e.g., system 10 or 110) is employed for printing an object on a fabric the height of the printed objects is below 10 cm, more preferably below 9 cm, more preferably below 8 cm, more preferably below 8 cm, more preferably below 7 cm, more preferably below 6 cm, more preferably below 5 cm, more preferably below 4 cm, more preferably below 3 cm, more preferably below 2 cm, more preferably below 1 cm.

In some embodiments of the present invention the fabrication process of a three-dimensional objects on the fabric includes dispensing on the fabric one or more layers of substance wherein the object is formed on the layers of the substance. The substance, alone or in combination with a pre-treatment process of the fabric (e.g. chemical, thermal and/or mechanical treatment) serves as an adhesive that ensure adherence between the fabric and the object. The substance can in some embodiments of the present invention be a modeling material, such as, but not limited to, the modeling materials marketed by Stratasys Ltd. under the trade names Vero™ and/or VeroUltra™ (e.g. VeroUltra™ Clear), which are relatively stiff and hard, once cured.

The Inventors of the present invention found that the type and potentially also the amount of the printed substance that provides adequate adherence level between the fabric and the printed object may depend on the type of the fabric to which the substance is to adhere the fabricated object. The Inventors have therefore devised a technique suitable for testing the adherence level of the substance to a specific fabric, alone or in combination with a pre-treatment process of the fabric, thereby allowing selecting the appropriate substance and/or pre-treatment combination for adequate adherence. The technique is based on a three-point bend test for testing adhesion of a coating. However, the Inventors found that a conventional three-point bend test is not suitable for testing adhesion to fabrics because while the conventional test is able to test adhesion of a thin coating to a relatively thick and rigid substrate, it is incapable of handling a situation in which the coated substrate is flexible and thin.

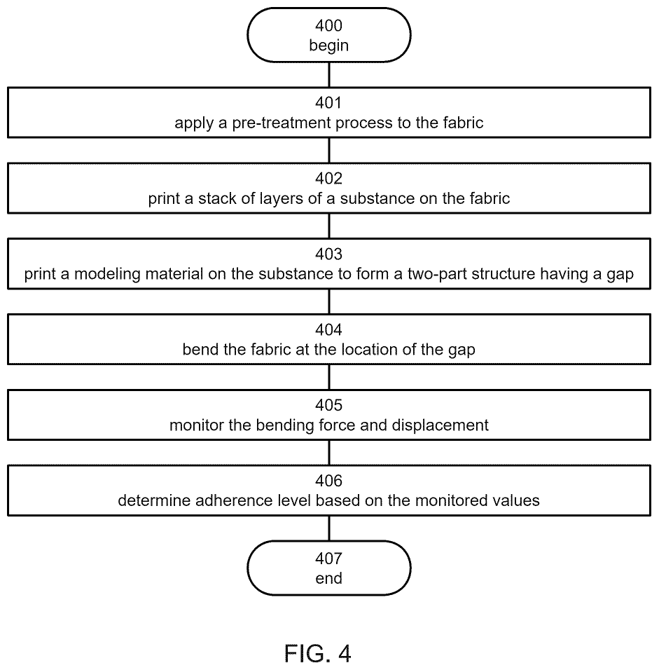

FIG. 4 is a flowchart diagram illustrating a method suitable for testing adherence level of a substance to a fabric, according to some embodiments of the present invention. The printing operations of the method are preferably executed by system 10 or 110.

The method begins at 400, and optionally and preferably continues to 401 at which a pre-treatment process is applied to the fabric. The pre-treatment process can include any chemical, thermal and/or mechanical treatment that is typically applied to fabrics. The method continues to 402 at which a stack of layers of the substance is printed on the fabric (optionally following ore-treatment 401), and to 403 at which a modeling material is printed onto the stack of substance layers. Since both operations 402 and 403 are executed by printing, the adherence between stack of substance layers and the modeling material that is printed on top of it is stronger than the adherence between the substance layers and the fabric.

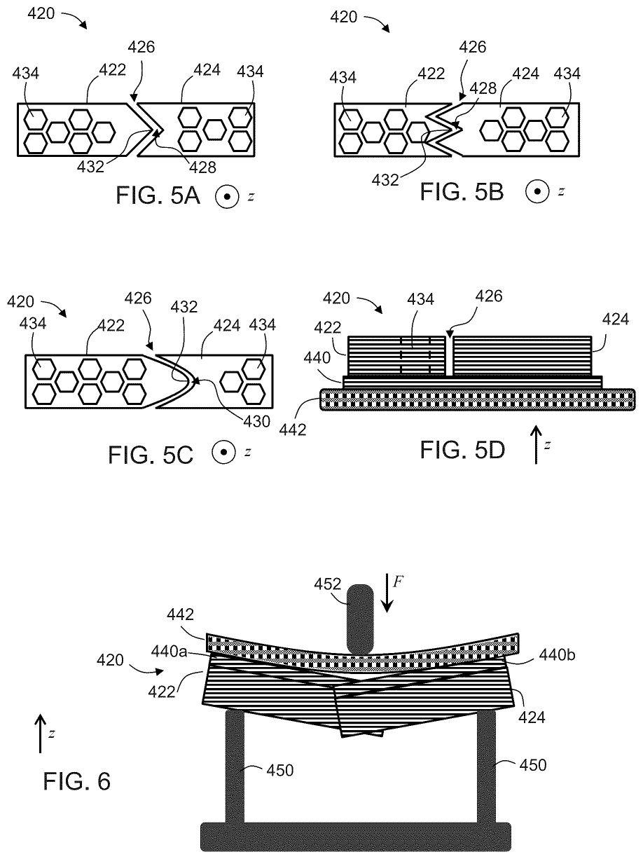

The modeling material is printed to form a two-part structure. Top views of representative examples of a two-part structure 420 suitable for the present embodiments are illustrated in FIGS. 5A-C, and a side view of a representative example of two-part structure 420 is illustrated in FIG. 5D. Two-part structure 420 is formed of a first stack 422 of modeling material layers that is laterally displaced from a second stack 424 of modeling material layers. The layers are stacked along the vertical direction z defined for the printing system (see FIGS. 1A and 1C), and the stacks 422 and 424 are displaced from each other along a horizontal direction that is perpendicular to the vertical direction. FIGS. 5A-C illustrate top views of structure 420, and so only the uppermost layer of each of stacks 422 and 424 is shown. In FIGS. 5A-C, the vertical direction z is shown as a circled dot indicating that it is directed out of the drawing's plane. A side view of the two-part structure 420, the stack 440 of substance layers and the fabric 442 is illustrated in FIG. 5D, showing also the vertical direction z as an upwardly pointing arrow.

In some embodiments of the present invention at least one of stacks 422 and 424 and more preferably both stacks 422 and 424 comprise a multiplicity of through holes 434 defining open cells in stacks 422 and 424. For example, the stacks 422 and 424 can have honeycomb structures. The through holes 434 are shown as hexagons in FIGS. 5A-C but they can have any other shape. The advantage of having through holes 434 in stacks 422 and 424 is that it reduces the likelihood of curling of the periphery of structure 420 relative to its center, during the printing process.

Stacks 422 and 424 are separated by a gap 426. The width of gap 426 is preferably uniform along the gap, but cases in which gap 426 has a non-uniform width are also contemplated in some embodiments. The width of gap 426 is preferably less than 1 mm, for example, from about 0.4 to about 0.9 mm. In experiments performed by the Inventors, widths of 0.5 mm, 0.7 mm and 0.9 mm were employed. While FIG. 5D shows a case in which the stack 440 of substance layers is formed also below the gap 426, this need not necessarily be the case, since, in some embodiments, it may be desired to configure the substance layers to have the same lateral shape as structure 420 and to be co-aligned vertically with it. In these embodiments, there are two stacks of substance layers, one stack aligned vertically below stack 422 and another stack aligned vertically below stack 424. A representative illustration of the case in which there are two gap-separated stacks 440a, 440b of substance layers is illustrated in FIG. 6, described below.

Two-part structure 420 is preferably elongated with planar width to length aspect ratio of from about 1:3 to about 1:10. The length of two-part structure 420, is defined as the aggerate lengths of stack 422 gap 426 and stack 424. Preferably the length of structure 420 is from about 50 mm to about 200 mm, and the width of structure 420 is preferably from about 10 mm to about 20 mm.

Gap 426 is optionally and preferably non-straight. In these embodiments, stacks 422 and 424 can be viewed as a male-female pair. For example, stack 422 can be defined as the male stack and stack 424 can be defined as the female stack. In some embodiments of the present invention gap 426 has a piecewise linear shape, as illustrated in FIGS. 5A and 5B, and in some embodiments of the present invention gap 426 has a curved shape, as illustrated in FIG. 5C. When the gap has a piecewise linear shape, it preferably forms an acute angle at one or more of its breakpoints 428. When the gap has a piecewise linear shape, it preferably has at least one apex 428. In the representative examples illustrated in FIGS. 5A-5C, the gap has a V shape (FIG. 5A), a W shape (FIG. 5B), and an arc shape (FIG. 5C), but other piecewise linear or curved shapes are also contemplated for gap 426. The advantage of having a gap with a breakpoint or apex is that it facilitates easy partial detachment of stack 422 and/or stack 424 from the fabric during a bend test. Specifically, a point 432 at the periphery of the male stack 422 that borders gap 426 and that is nearby (e.g., closest to) the breakpoint 428 or apex 430 can be a detachment point in the sense that the adhesion forces between the structure 420 and the fabric are the weakest in the vicinity of detachment point 432.

In various exemplary embodiments of the invention each of stacks 422, 424 has a bending resistance that is higher than the bending resistance of stack 440 of substance layers as well as than the bending resistance of fabric 442. This can be achieved by selecting the modeling material of structure 420 to be stiffer than the substance 440 and the fabric 442, and/or by making the thickness of stacks 422, 424 along the vertical direction z larger than the thicknesses of stack 440 and fabric 442. Preferably, the thicknesses of stacks 422 and 424 are at least two times larger more preferably at least three times larger than the thickness of stack 440. In some embodiments, the thicknesses of stacks 422 and 424 are at least two times larger more preferably at least three times larger than the thickness of the fabric 442.

A typical thickness for stack 440 is from about 0.1 mm to about 1 mm, more preferably from about 0.2 mm to about 0.9 mm, more preferably from about 0.2 mm to about 0.8 mm. A typical thickness for stacks 422 and 424 is from about 1 mm to about 4 mm, more preferably from about 1.6 mm to about 3 mm, more preferably from about 2 mm to about 3 mm. In experiments performed by the Inventors thicknesses of 0.3 mm and 0.6 mm were employed for stack 440 and a thickness of 2.2 mm was employed for stacks 422 and 424.

Referring back to FIG. 4, the method continues to 404 at which the fabric 442 is bent at the location of gap 426 so as to detach at least one of stacks 422 and 424 from the fabric at detachment point 432. A preferred procedure for executing operation 404 is illustrated in FIG. 6. Structure 420 is placed on a pair 450 of supporting pillars such that it is simply supported by pair 450. Preferably structure 420 contacts pillar pair 450 and fabric 442 is away from pillar pair 450. A force applying pin 452 is brought to engage fabric 442 at proximity to the location of the gap 426 (not shown in FIG. 6), and a force F is applied by pin 452 perpendicularly to fabric 442, generally at the direction of pair 450, causing fabric 442 to bend into the space between the pillars of pair 450. Since the bending resistance of stacks 422 and 424 is higher, they begin to detach from fabric 442 (together with the stack 440, which is more strongly attached to structure 420 than to fabric 442), at the points of weakest adhesion, which are in the vicinity of the gap.

It is appreciated that the operation 405 provides a qualitative assessment of the level of adherence of the substance to the fabric. When it is desired to have a more quantitative assessment of the level of adherence, the method can continue to 406 at which the magnitude of the force F and the strain of fabric 442 are monitored, e.g., by recording the displacement of pin 452 and the force applied by it. The method can then determine the adherence level of the substance to the fabric based on the monitored values. For example, the monitored values can be analyzed to identify a maximal load at which there is an abrupt change in the correlation between the force and the displacement, and this maximal load can be defined as the level of adherence. Typically, the displacement grows generally linearly with the force until the force reaches the maximal load. When the displacement is larger than the displacement at the maximal load, there is no longer a linear growth of the displacement with the force. Oftentimes at this stage, there is a negative correlation between the displacement and the force. The maximal load can thus be identified as the force at which the linear growth of the displacement with the force terminates.

The method ends at 407.

It is recognized that curable building material formulations exhibit a phenomenon known as curing shrinkage, wherein the volume of the material post curing is smaller than the respective formulation immediately after its dispensing. The inventors found that for some modeling material formulations that lateral curing shrinkage is more pronounced than for other formulations.

As used herein “lateral curing shrinkage” refers to the reduction of the diameter of a printed region as measured along a lateral direction that is perpendicular to the vertical z direction.

The inventors found that when a formulation that exhibits a considerable lateral curing shrinkage is adhered to a fabric, the curing shrinkage results in appearances of wrinkles or other geometrical irregularities on the fabric. Typically, when such a formulation forms a region on the fabric, then, following curing, the inner part of such a region tends to detach from the fabric even though the periphery of the region is still properly adhered to the fabric. This generates geometrical irregularities in the fabric since the detached portion lifts up and displaces the undetached portion at the periphery inwardly.

The inventors found that the above problem is particularly pronounced when using a modeling formulation that cures into a soft and flexible modeling material, e.g., a modeling material having a tensile strength of from about 2 to about 4 MPa according to ASTM D-412 and a Shore A hardness from about 25 MPa to about 35 MPa according to ASTM D-224D. Representative examples of soft and flexible modeling material include, without limitation, the Agilus™ family of materials (e.g., Agilus30™²⁶Clear, and Agilus30™) and the Tango™ family of materials (e.g., TangoPlus™, TangoBlackPlus™, TangoGray™, TangoBlack™), all by Stratasys® Ltd., Israel.

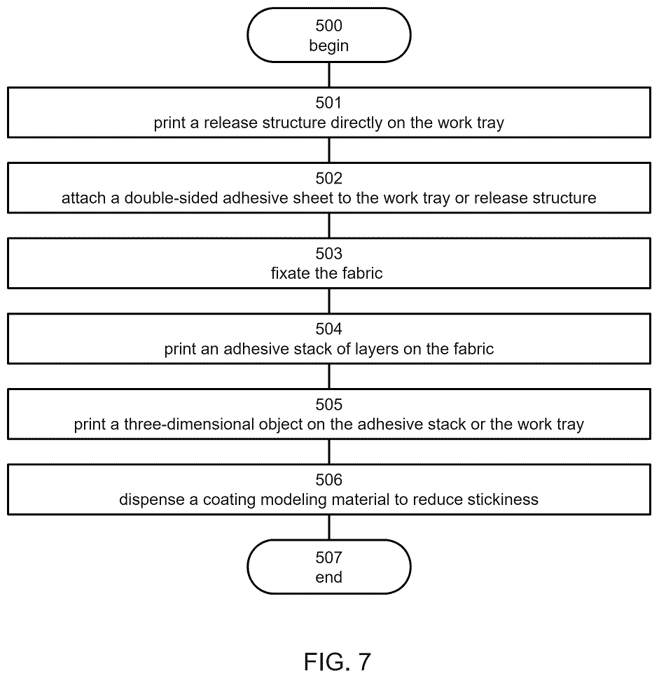

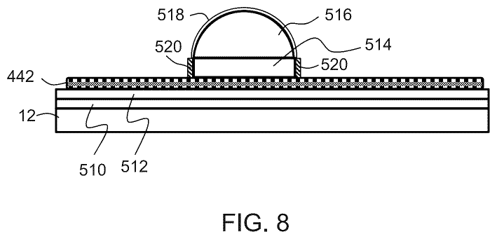

The inventors found a solution to this problem, by devising a printing technique that reduces or eliminates the amount of geometrical irregularities created during the curing of the modeling material. In some embodiments of the present invention the printing technique improves the adherence of the modeling material to the fabric, in some embodiments of the present invention the printing technique improves the fixation of the fabric to the work tray, and in some embodiments of the present invention the printing technique employs both said improvements. The printing technique of the present embodiments will now be explained with reference to FIG. 7, which is a flowchart diagram of a method suitable for three-dimensional printing on a fabric, and to FIG. 8 which is a schematic illustration showing the printed three-dimensional object.

The method begins at 500 and optionally and preferably continues to 501 at which a release structure 510 of modeling material is printed on the work tray. Preferably, release structure 510 is printed to cover at least 90% of the area of the work tray. The modeling material used for printing the release structure 510 is preferably relatively stiff and hard, and can be, for example, any of the aforementioned Vero™ family of materials (Vero™, VeroUltra™, and VeroUltra™ Clear). Release structure 510 is preferably devoid of any support material. Typically, release structure 510 includes at most five more preferably at most four more preferably at most three (e.g., one or two) layers of modeling material. Typically, each layer of modeling material is from about 20 to about 70 microns, in thickness, and so the overall thickness of release structure 510 is from about 20 microns to about 350 microns.

The method optionally and preferably continues to 502 at which a double-sided adhesive sheet 512 is attached to the release structure 510. In embodiments in which operation 501 is skipped, and it is desired to use a double-sided adhesive sheet, the adhesive sheet 512 is attached directly on the work tray 12 of the printing system (e.g., system 10 or 110). The advantage of using double-sided adhesive sheet 512 is that it improves the fixation of fabric 442 to tray 12, and reduces the likelihood of formation of geometrical irregularities. The advantage of the release structure 510 is that it facilitates easy removal of the adhesive sheet 512 once the fabrication of the three-dimensional object on the fabric is completed. The double-sided adhesive sheet 512 can be of any type known in the art and is preferably applied on the entire area of the work tray.

The method continues to 503 at which the fabric 442 is fixated in the system (e.g., system 10 or 110), optionally and preferably after pre-treatment as further detailed hereinabove. In embodiments in which operations 501 and 502 are skipped, fabric 442 is fixated to the work tray 12 of the system. In embodiments in which operations 501 and 502 are executed fabric 442 is fixated by attaching it to the opposite side of double-sided adhesive sheet 512. In any event, the fabric is preferably fixated by means of a jig.

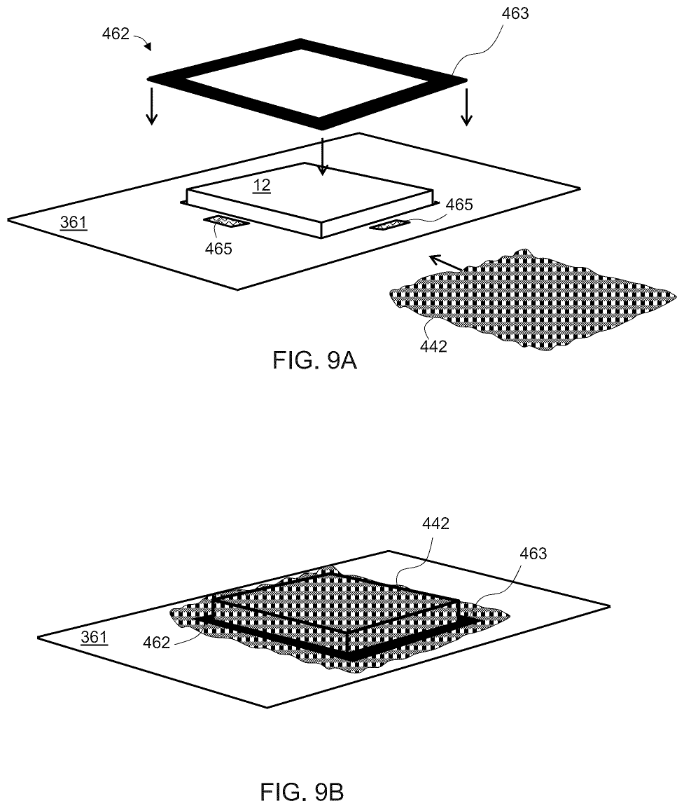

A preferred configuration for a jig 462 is schematically illustrated in FIGS. 9A-B. The release structure and adhesive sheet are not illustrated in FIGS. 9A-B. In these embodiments jig 462 comprises a magnetic or metallic frame 463 and one or more magnetic or metallic elements 465, wherein elements 465 are attached, preferably permanently, to tray 12 or adjacent thereto, e.g., onto a supporting platform 361 supporting tray 12, and wherein at least one of tray 12 and elements 465 comprises a permanent magnet to ensure mutual magnetic attraction between elements 465 and frame 463. FIG. 9A illustrates jig 462 in its opened state, before fabric 420 is placed on the work tray 12, and FIG. 9B illustrates jig 462 in its closed state wherein frame 463 is magnetically attached to elements 465 (not shown in FIG. 4B), fixating and optionally and preferably stretching fabric 442 onto work tray 12. Jig 462 can also comprise a pair of frames 463 magnetically attachable to each other, in which case the fabric 462 is stretched between the frames of jig 462 before it is placed on work tray 12. In these embodiments, elements 465 are not necessary. Additional configurations for a jig 462 are described in WO2022/024114 supra, the contents of which are hereby incorporated by reference.

Referring back to FIGS. 7 and 8, the method optionally and preferably continues to 504 at which an adhesive stack 514 of layers is printed onto fabric 442. The adhesive stack 514 is preferably made of a modeling material that does not significantly exhibit lateral curing shrinkage. A representative example includes, without limitation, any of the aforementioned Vero™ and VeroUltra™ families of materials.

The inventors surprisingly found that a modeling material that facilitates release of the adhesive sheet 512 from the tray 12, can also serve as an adhesive. Thus, in some embodiments of the present invention the adhesive stack 514 is made of the same modeling material as the release structure 510. These embodiments are preferred from the standpoint of simplicity since there is no need to allocate different modeling material cartridges to the release structure and the adhesive stack.

The modeling material from which the layers of the adhesive stack 514 are made can be formed of a single modeling formulation, or it can be a digital modeling material formed of two or more different modeling formulations in an interlaced manner as further detailed hereinabove.

Whether to use for adhesive stack 514 a modeling material formed of a single modeling formulation or to use a digital modeling material, preferably depends on the desired foldability of the three-dimensional object to be printed on fabric 442. Specifically, when it is not desired to print a foldable object, the layers of adhesive stack 514 can be made of a modeling material formed of a single modeling formulation, and when it is desired to print a foldable object, the layers of adhesive stack 514 can be made of a digital modeling material.

Preferably the digital modeling material for adhesive stack 514 is made of a modeling formulation that provides, once cured, a relatively stiff and hard material (such as, but not limited to, any of the aforementioned Vero™ and VeroUltra™ families of materials), and a modeling formulation that provides, once cured, a relatively flexible and soft material (such as, but not limited to, any of the aforementioned Agilus™ family of materials). The relative spatial distribution of the modeling formulations for the adhesive stack can be selected based on the desired foldability. Thus, in some embodiments of the present invention the method receives input pertaining to a selected foldability of the three-dimensional object to be printed, and selects the relative spatial distribution of the modeling formulations based on the selected foldability. The input pertaining to a selected foldability can be in the form of a score selected from a list of scores prepared in advance, and the relative spatial distribution can be determined using an appropriate lookup table associating a foldability score with a relative spatial distribution.

The adhesive stack 514 typically comprises less than 20 layers, more preferably less than 18 layers, more preferably less than 16 layers, more preferably from about 5 layers to about 15 layers. For the aforementioned range of single-layer thicknesses, this corresponds to an overall thickness of the adhesive stack of from about 100 microns to about 1.4 mm.

For aesthetic reasons, in embodiments in which stack 514 is printed, it may be desired in some embodiments to print stack 514 together with a peripheral skirt 520 laterally surrounding stack 514. Peripheral skirt 520 serves for hiding stack 514 is and is preferably printed with a modeling material having a color that is similar to the color of the object to be fabricated or the color of fabric 442.

The method continues to 505 at which a three-dimensional object 516 is printed by dispensing one or more modeling materials in a configured pattern corresponding to the shape of the object. In embodiments in which adhesive stack 514 is printed on the fabric (operation 504) object 516 is printed on stack 514. In embodiments in which operation 504 is skipped, object 516 is printed on fabric 442. During operation 505 the printing system (e.g., system 10 or 110) dispenses at least one modeling material that exhibits a relatively high extent of lateral curing shrinkage. For example, at least one of the modeling materials dispensed during operation 505 can be a soft and flexible modeling material, such as, but not limited to, a modeling material having the aforementioned tensile strength and Shore A hardness, e.g., representative examples of soft and flexible modeling material include, without limitation, a modeling material of the Agilus™ family or the Tango™ family.

When operation 504 is executed, at least one of the modeling materials that are dispensed to form object 516 preferably has a lateral curing shrinkage that is higher than the lateral curing shrinkage of the modeling material dispensed to form the adhesive stack 514. The advantage of operation 504, is that adhesive stack 514 facilitates better adherence between the three-dimensional object 516 and the fabric 442, eliminating or reducing the extent of the aforementioned lift-up of the inner portion.

The inventors found that outer surfaces of objects made of soft and flexible modeling materials may oftentimes exhibit a sticky feeling when contacted by a bare hand or finger. This property may be undesirable from the standpoint of end-user experience. The inventors additionally found that the stickiness of the outer surface of the object can be significantly reduced by employing a thin coating. Thus, according to some embodiments of the present invention the method proceeds to 506 at which a coating modeling material 518 is dispensed on an outermost surface of object 516, wherein the stickiness of the coating modeling material 518 is less than the stickiness of the outermost surface of object 516. The coating modeling material 518 is preferably transparent so as not to interfere with the colors of the outer surface of the object 516.

The term “transparent” describes a property of a material that reflects the transmittance of light therethrough. A transparent material is typically characterized as capable of transmitting at least 70% of a light that passes therethrough, or by transmittance of at least 70%. Transmittance of a material can be determined using methods well known in the art.

Representative examples of modeling materials suitable for the present embodiments include, without limitation, materials having the trade names RGD720, MED610™, MED625FLX™, all commercially available from Stratasys Ltd., Israel. Additional transparent modeling materials are described in International Publication Nos. WO 2020/065654, and WO2021/014434.

Operation 506 is preferably executed to provide a thin coating to the outer surface of the object. Typically, the method dispenses at most three layers of coating modeling material 518, more preferably at most two layers of coating modeling material 518, and most preferably a single layer of coating modeling material 518. For the aforementioned range of single-layer thicknesses, this corresponds to an overall coating thickness of from about 20 microns to about 210 microns.

The Inventors found that an excessive amount of coating modeling material may result in undesired wetting of the fabric at regions adjacent to the coated object. The Inventors therefore devised a technique that further reduces the amount of coating modeling material being used, without compromising on the ability of the coating modeling material to reduce or eliminate the stickiness. Thus, in some embodiments of the present invention the coating modeling material is dispensed on certain regions of the outermost surface of the object, and is not dispensed on other regions of the outermost surface. Generally, the coating modeling material is dispensed exclusively on regions having geometrical properties that satisfy a predetermined criterion or set of criteria. In some embodiments, the coating material is dispensed only on regions of the outermost surface that are shape-wise and size-wise compatible with a predetermined continuous hull. The continuous hull approximates the shape of the outer surface and can be a pricewise linear hull, e.g., an alpha-shape, or a curved shape. A representative method for identifying the points at which the coating modeling material is to be dispensed is described below.

The method ends at 507.

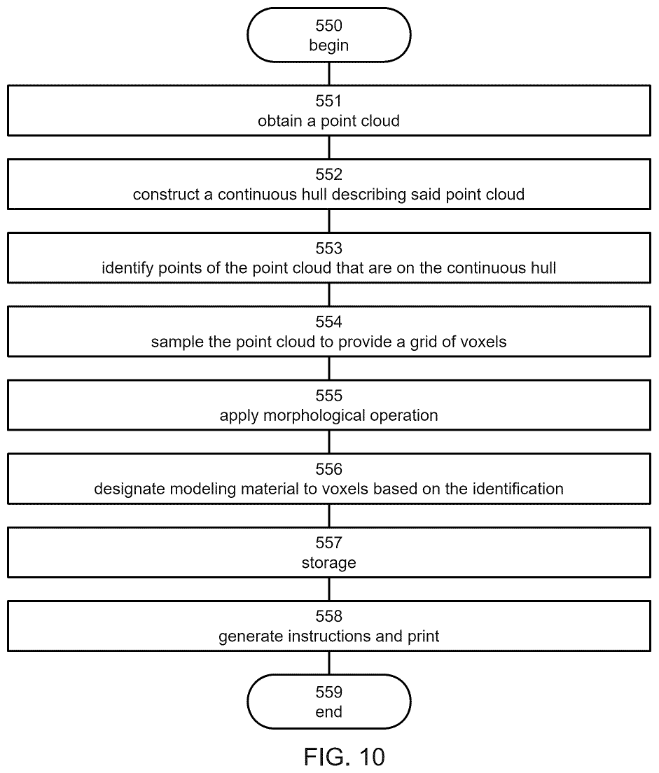

FIG. 10 is a flowchart diagram of a method suitable for processing data for printing of a three-dimensional object, according to some embodiments of the present invention.

Computer programs implementing the method can commonly be distributed to users on a distribution medium such as, but not limited to, a flash memory, CD-ROM, or a remote medium communicating with a local computer over the internet. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method. All these operations are well-known to those skilled in the art of computer systems.

The method can be embodied in many forms. For example, it can be embodied on a tangible medium such as a computer for performing the method steps. It can be embodied on a computer readable medium, comprising computer readable instructions for carrying out the method steps. In can also be embodied in an electronic device having digital computer capabilities arranged to run the computer program on the tangible medium or execute the instruction on a computer readable medium.

The method of the present embodiments can be executed by a data processor operating an AM system (e.g., data processor 24). The computer object data processed by the method can be transmitted to the controller of the AM system (e.g., controller 20). The processed computer object data can be transmitted in its entirety before the AM process begins, or in batches (e.g., slice by slice) wherein the AM process begins after the first batch arrives but before receiving the last batch. The method of the present embodiments can alternatively be executed by the controller of the AM system (e.g., controller 20). In these embodiments, the controller receives input data and execute the method using these input data. The input data can be received by the controller before the AM process begins, or in batches, wherein the AM process begins after the first batch arrives but before receiving the last batch.

The method begins at 550 and optionally and preferably continues to 551 at which a point cloud describing an outer surface of the object is obtained. The point cloud can be received from an external source. Alternatively, the method can receive computer object data including a plurality of graphic elements as further detailed hereinabove, and transform the graphic elements to the point cloud. The density of the point cloud can be similar to the resolution of the printing system.

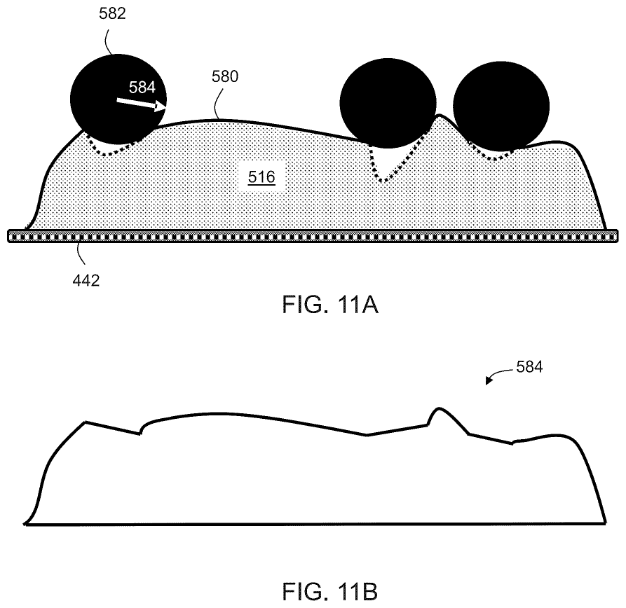

The method continues to 552 at which a continuous hull describing the point cloud is constructed. In some embodiments of the present invention continuous hull is constructed using a moving elementary shape having a predetermined elementary size in a manner that no point of the point cloud is within the elementary shape. The procedure is illustrated in FIGS. 11A-B. Shown in FIG. 11A is object 516 (in the case in which it is printed directly on fabric 442) and its outermost surface 580, represented by the computer as a point cloud. An elementary shape 582 of fixed and predetermined size is constructed by the computer. A typical value for the predetermined size is from about 1 mm to about 20 mm. Optionally and preferably, the predetermined size corresponds to an approximate typical width of a human's finger, e.g., about 10 mm.

In the schematic illustration shown in FIG. 11A, the elementary shape 582 is a disc or a circle, in which case the predetermined size can be expressed as its radius 584 (shown as a white arrow). Elementary shapes other than a disc or a circle are also contemplated in some embodiments of the present invention. The computer moves the elementary shape 582 in an oscillating manner across the point cloud such that the elementary shape 582 remains outside object 516. FIG. 11A illustrates three representative positions of elementary shape 582. The points of the oscillation between the elementary shape 582 and the cloud are marked, and are thereafter connected to form a continues hull 584 shown in FIG. 11B. The points can be connected by straight lines or planar triangles in which case the continues hull 584 is a piecewise linear hull. The points can also be combined with curved lines in which case the continuous hull 584 is curved. In the particular case in which the elementary shape 582 is a disc and the continuous hull 584 is a piecewise linear hull, the continuous hull 584 is referred to as an alpha-shape.

From 552 the method continues to 553 at which the method identifies points of the point cloud that are on continuous hull 584. The identified points are collectively illustrated in FIG. 11A as solid lines. The points that are not on hull 584 are collectively illustrated in FIG. 11A as dotted lines.

The method continues to 554 at which the point cloud is sampled to provide a grid of voxels, and optionally and preferably also to 555 at which a morphological operation is applied to the grid of voxels. Typically, morphological operation includes dilation. The method proceeds to 556 at which a modeling material is designated to at least a portion of the voxels based on the identification. For example, the method can designate a coating modeling material for each voxel that corresponds to an identified point, and a different modeling material to at least a portion of all other voxels. In embodiments in which morphological dilation is applied, voxels that are added by the dilation operation are designated with the same modeling material as voxels that correspond to identified points.

At 557 the method stores the grid of voxels and the material designations in a computer readable medium. In some embodiments, the method continues to 558 at which dispensing instructions are generated for at least a portion of the voxels based on the designation, and are then used for printing a three-dimensional object.

The method ends at 559.

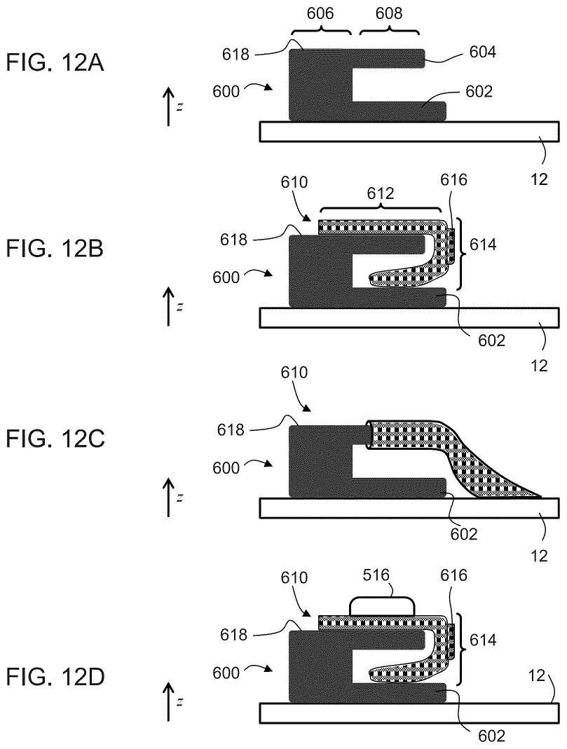

Reference is now made to FIG. 12A-D which is a schematic illustration of a method of three-dimensional printing on a garment, according to some embodiments of the present invention. The method begins by printing a modeling material on a work tray 12 to form a ramp 600 having an upper horizontal surface 618 that is elevated above work tray 12 (FIG. 12A). Ramp 600 can have a simple cuboid shape, or any other shape. In the schematic illustration of FIG. 12A ramp 600 has a base 602 in contact with work tray 12, and an upper platform 604 having a portion 606 that is supported by base 602 and an overhanging portion 608.

A garment 610 is placed on the upper surface 618 of ramp 600 (FIG. 12B). Garment 610 has a region 612 of uniform thickness and a region 614 of non-uniform thickness. Region 614 of non-uniform thickness can include any garment feature 616 such as, but not limited to, a stitch, a seam, a pocket, a zipper, a button, a collar, a hood, a sticker, a waist belt, a fly piece, a knot, a strap, a fastener, and the like. Garment 610 is placed on ramp 600 in a manner that region 612 of uniform thickness is on the upper surface 618 of ramp 600, and region 614 of non-uniform thickness is at a vertical position along the vertical z direction that is below the upper surface 618 of ramp 600. A portion of garment 610 can also be placed below hanging portion 608 of ramp 600, as illustrated in FIG, 12B. Having region 614 below the uppermost surface ramp 600 allows printing on garment 610 while avoiding the risk of collisions between the garment features 616 and the dispensing heads of the printing system. The advantage of ramp 600 is, therefore, that it allows printing using a dispensing head that is in close proximity to the garment even in cases in which the garment includes non-planar regions.

Another advantage of ramp 600 is that it is printed according to the system-of-coordinates of the printing system, and therefore can serve as a reference frame for accurate positioning of garment 612. Thus, the lateral dimensions of ramp 600 can be specific to the object to be manufactured, e.g., delineating the borders of a region on the garment 610 on which it is desired to manufacture the three-dimensional object. In these embodiments, garment 610 is preferably placed on ramp 600 after ramp 600 is printed, and without dislocating or removing ramp 600 from tray 12.

When garment 610 has a tubular part (e.g., a sleeve, a leg, a pocket, a sock, a glove, etc.), the tubular part can be pulled over the hanging portion 608 of ramp 600, as illustrated in FIG. 12C.

Once the garment is placed on ramp 600 a three-dimensional object 516 is printed on the region 612 of uniform thickness (FIG. 12D). The printing procedure can include any of the operations described above.

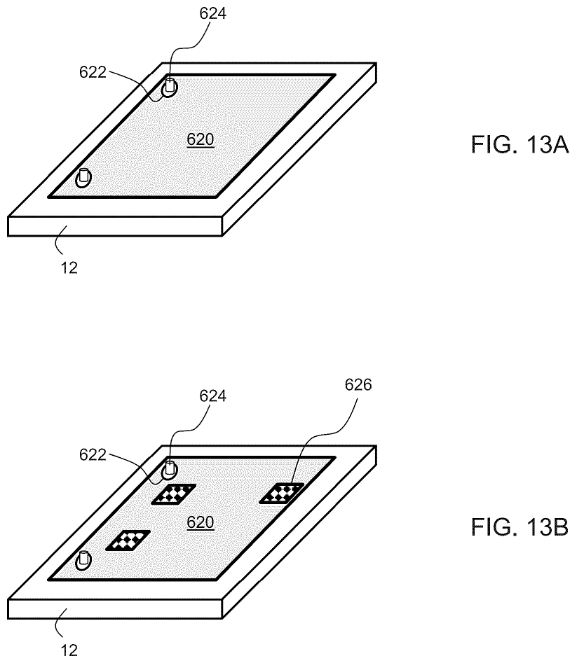

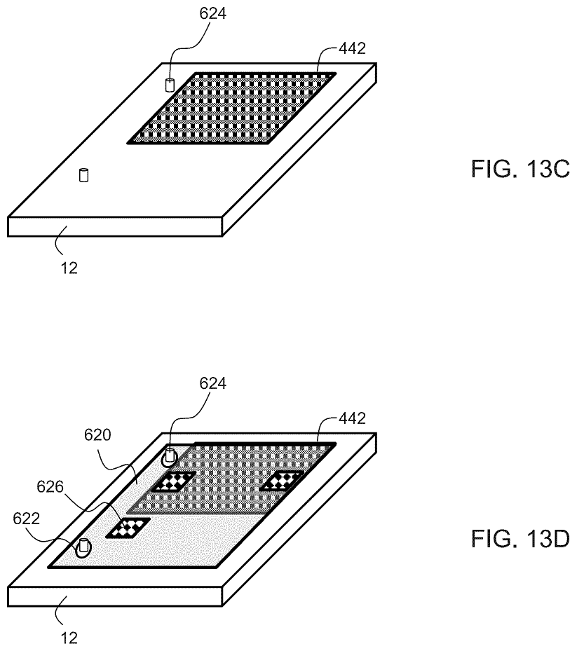

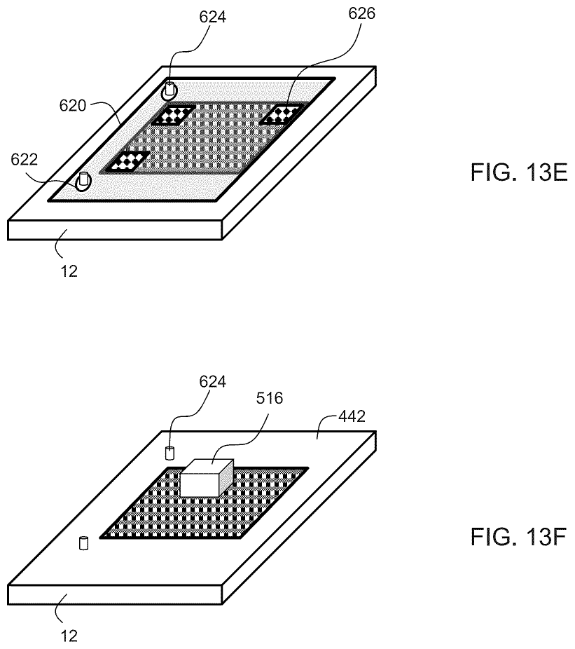

Reference is now made to FIG. 13A-F which are schematic illustrations of a method suitable for aligning a fabric for three-dimensional printing. The method begins by fixating a transparent slide 620 to work tray 12 at a lateral position relative to work tray 12 (FIG. 13A). The lateral position is typically predetermined. For example, slide 620 can have holes 622 at locations that match locations of respective pins 624 on tray 12 or some extension thereof (not shown).

A modeling material is then dispensed to form alignment marks 626 onto slide 620 (FIG. 13B). Marks 626 can be at predetermined locations over slide 620 irrespectively of the object to be manufactured or the fabric to on which be object is to be manufactured. For example, marks 626 can be arranged to delineate a grid describing the system-of-coordinate of the printing system (e.g., system 10 or 110) at the horizontal plane (the x-y or r-φ plane). Alternatively, the locations of the marks can be specific to the object to be manufactured, e.g., delineating the borders and/or one or more other special points (e.g., center, symmetry axis, etc.) of the bottommost layer of object. Still alternatively, or additionally, the locations of the marks can be specific to the fabric on which the object is to be manufactured, e.g., delineating a wove pattern or colored regions of the fabric or, when it is desired to manufacture the object near one of the ends of the fabric, the border of this end.

The slide 620 is then removed from work tray 12 and fabric 442 is fixated thereon (FIG. 13C). Preferably, the periphery of fabric 442 is fixated using a jig (not shown, see FIGS. 9A and 9B). The method proceeds by fixating transparent slide 620 on the fabric at the same lateral position relative to tray 12 at which slide 620 was placed when marks 626 were printed (FIG. 13D). This can be ensured using holes 622 and pins 624. The method proceeds by adjusting the lateral position of fabric 422 based on the alignment marks 626 (FIG. 13E). Typically, the operator temporarily lifts the slide 620, adjusts the position of fabric 442, returns the slide to the same lateral position, and checks whether marks 626 are at the desired lateral locations relative to the fabric 442. The operator can repeat the procedure in a trial-and-error way until the operator is satisfied with the alignment of fabric 442 relative to the locations of marks 626. The Inventors found that the number of iterations that are required to properly align the fabric is low, typically two to four iterations.

Slide 620 is then removed from fabric 442, and object 516 is manufactured by three-dimensional printing (FIG. 13F). The printing procedure can include any of the operations described above. The aforementioned method has been found particularly useful by the Inventors when it is desired to align the 3D object with graphical elements appearing in the fabric (e.g., printed on top, or between such graphical elements).

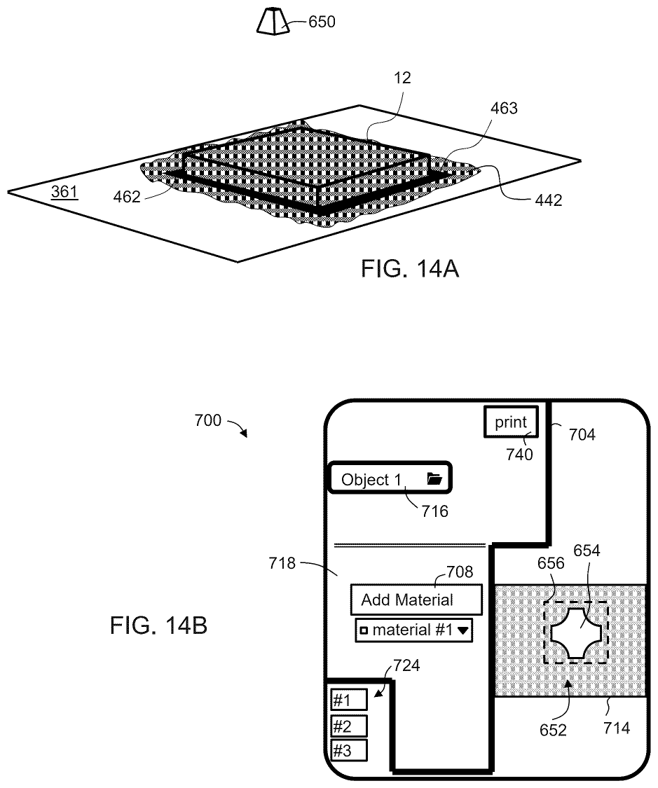

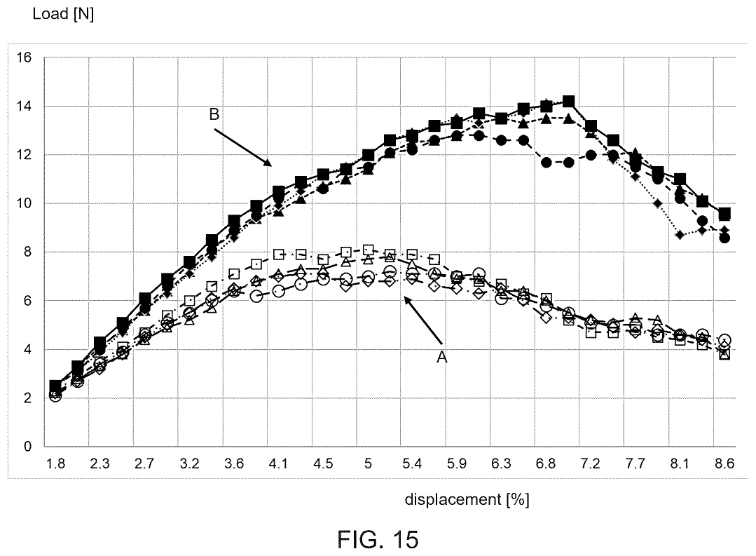

Reference is now made to FIG. 14A-B which are schematic illustrations of a method suitable for automatically aligning a fabric for three-dimensional printing. In these embodiments, the printing system (e.g., system 10 or 110) comprises an imaging system 650 (see FIG. 14A) that can be mounted on the frame or block on which the dispensing heads and solidification source are mounted (not shown in FIG. 14A, see, FIG. 1A). In some other embodiments, imaging system 650 is external/independent from the printing system, and a removable jig 462 including tray 12 and frame 463, together with fabric 442, may be first placed within said external imaging system 650 before being placed in the printing system. The field-of-view of imaging system 650 preferably encompasses at least 80% of the area of tray 12, or at least 90% of the area of tray 12, e.g., the entire area of tray 12. The system-of-coordinates of imaging system 650 is registered with respect to a lateral system-of-coordinates of the printing system, so that any pixel of an image captured by imaging system 650 is described in the system-of-coordinates of the printing system, and therefore the lateral location of such a pixel is addressable by the controller of the printing system. Typically, such a co-registration between the system-of-coordinates of the imaging system and the system-of-coordinates of the printing system is executed by a technician upon deployment of the printing system, and also following any maintenance of the printing system, e.g., replacement of tray 12 or the like.

The fabric 442 is fixated to the tray 12 by jig 462, and imaging system 650 is operated to generate an image of fabric 442. A computer, e.g., computer 24 is used to display a graphical user interface (GUI) 700 showing the captured image 652. GUI 700 provides an easy to use interface between the end-user of the printing system 10/110 and the computer 24. GUI 700 includes a plurality of computer-generated objects, which are referred to as “GUI controls”, or in more abbreviated term “controls.” Representative examples of GUI controls suitable for the present embodiments include, without limitation, a slider, a dropdown menu, a combo box, a text box and the like.

The GUI controls are responsive to physical operations performed by the user by means of devices that communicate signals to the computer. Such devices can be a computer mouse, a touch screen, a keyboard or the like, and may optionally include a microphone in which case the computer is configured to execute voice-activated software. GUI 700 can optionally and preferably display additional information, such as non-interactive text and graphics.

During operation, the end-user can select and activate the controls in order to initiate operations to be executed by the processor of the computer. GUI 700 transmits activation signals to the processor, for example, by means of an I/O circuit configured to communicate signals between GUI 700 and the processor. The activation signals can be transmitted to the processor either upon activation of the respective control, or at a later time (e.g., upon activation of another control). The controls are represented on GUI 700 as graphical elements that are optionally and preferably labeled in a manner that is indicative of the operation that the processor executes responsively to the activation of these controls. The controls may be arranged in predefined layouts, or may be created and/or removed dynamically responsively to specific actions being taken by the end-user by means of other GUI controls. By way of example, a user may select a button that opens or closes another control, expands a control, displays an image, and/or switches between GUI layouts (oftentimes referred to as GUI screens).

GUI 700 can comprise a user selection area 704, and a visualization area 714. Image 652 is displayed at visualization area 714, optionally and preferably together with a grid of GUI coordinates (not shown) that are co-registered with the lateral system-of-coordinates of the printing system. User selection area 704 can comprise an object selection control 716 that allows the user to select an object to be printed, for example by browsing the file system of the computer and selecting a file stirring computer object data describing the selected object.

Optionally and preferably GUI 700 also comprises a material selection area 718, having a material selection control 708 which can be in the form of one or more dropdown menus allowing to select the material from a predefined list of materials. Also contemplated, are embodiments in which GUI 700 comprises a material information area 724 that displays the types of building materials that are currently loaded to the printing system. This can be achieved by transmitting an interrogating signal to the printing system (e.g., to controller 20), and responsively receiving a signal pertaining to the types of building materials that are currently loaded to the printing system. Typically, the interrogating signal is transmitted automatically by the computer immediately after the loading of GUI 700. Preferably, material selection control 708 is configured to allow selection only among the types of building materials that are currently loaded to the system. For example, materials that are not currently loaded into the system can be grayed out in the dropdown menu of control 708. Material information area 524 can optionally and preferably also display an indication regarding the materials that are already in use for the designed planar pattern.

Once the user selects an object to be printed by means of control 716 a graphical representation 654 of the object is overlaid on image 652 in visualization area 714. Visualization area 714 serves also as a graphical control area which allows dragging or otherwise manipulating graphical representation 654 across image 652. The graphical representation 654 is displayed at a GUI location 656 that is described by the same lateral system-of-coordinates of the printing system. The user can adjust the location 656 of graphical representation 654 relative to the image 652 of fabric 442, for example, by dragging graphical representation 654 across image 652, until the user is satisfied with the alignment of the object on the fabric.

GUI 700 also comprises a print activation control 740, which can be in the form of a GUI button. Upon activation of print activation control 740, a command is transmitted to the printing system by the computer to print the object on the fabric at a physical location that corresponds to the display location.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Adherence Level Test

Experiments were performed to test the adherence level of two substances to a fabric. For each tested substance a stack of layers of the substance was printed on the fabric, and the two-part structure 420 of the type shown in FIG. 5A was printed on the stack of substance layers. All experiments were executed, generally simultaneously on the same fabric sample, by printing the respective stacks at different locations on the fabric sample.

After printing, the fabric sample was cut to multiple samples each carrying one of the printed structures. Load testing was executed after 24 hours, using an Instron program, 100N load cell, and 3 points bend jig, as described above with reference to FIG. 6. The results, for eight different experiments are shown in FIG. 15. The four results shown marked by “A” correspond to experiments for one of the tested substances, and four results shown marked by “B” correspond to experiments for the other tested substance. In all experiments, the overall thickness of the stack 440 of substance layers was about 0.3 mm. For each tested substance, each of the four experiments was conducted using a different modeling material for the two-part structure 420.

In FIG. 15, the ordinate presents the load read in Newtons [N] and the abscissa presents the displacement of pin 452, normalized to percentage. As shown, the force increases generally with the same similar modulus of elasticity with the advance of the displacement until a maximal point, representing the detachment of the substance from the fabric. From this point on the force decreases gradually. FIG. 15 demonstrates that the test method is reproducible and does not generally depend on the type of modeling material used for the two-part structure 420. Yet, significant differences exist between the results for substances “A” and “B” demonstrating high specificity of the test method.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1-42. (canceled)

43. A method of aligning a fabric for three-dimensional printing, the fabric being fixated to a work tray of a printing system, the method comprising:
operating an imaging system to generate an image of the fabric, said image being registered with respect to a lateral system-of-coordinates of the printing system;
displaying a graphical user interface (GUI) showing said image; and
overlaying said image with a graphical representation of the object at a GUI location described by said lateral system-of-coordinates.

44. The method according to claim 43, comprising transmitting a command to said printing system to print the object on the fabric at a physical location corresponding to said display location.

45. The method according to claim 43, further comprising co-registering a system-of-coordinates of said imaging system with said lateral system-of-coordinates of the printing system.

46. The method according to claim 43, further comprising fixating the fabric to the work tray by a jig.

47. The method according to claim 43, wherein said imaging system is mounted on a frame on which a dispensing head of the printing system is also mounted.

48. The method according to claim 43, wherein said imaging system is external to the printing system, and the method comprises placing the work tray together with the fabric within said external imaging system, and thereafter placing the work tray together with the fabric in the printing system.

49. The method according to claim 43, wherein a field-of-view of said imaging system encompasses at least 80% of an area of the work tray.

50. The method according to claim 43, comprising placing at least a portion of the fabric on a structure that is in contact with the work tray and that comprises an upper horizontal surface that is elevated above the work tray.

51. The method according to claim 50, comprising printing said structure on said tray and placing said at least said portion of the fabric on said structure.

52. The method according to claim 50, wherein the fabric has a region of uniform thickness and a region of non-uniform thickness, and wherein said placing is so as to ensure that said region of uniform thickness is on said structure, and said region of non-uniform thickness is at a vertical position below said upper horizontal surface.

53. The method according to claim 52, wherein said region of non-uniform thickness is selected from the group consisting of a stitch, a seam, a pocket, a zipper, a button, a collar, a hood, a sticker, a waist belt, a fly piece, a knot, a strap, and a fastener.

54. The method according to claim 50, wherein said structure comprises an overhanging portion, and the method comprises placing a portion of said garment below said overhanging portion.

55. The method according to claim 50, wherein said structure comprises an overhanging portion, wherein the garment has a tubular part, and wherein the method comprises pulling said tubular part over said hanging portion.

56. A system for three-dimensional printing, comprising:
a printing system having a work tray for supporting fabric thereon, and a dispensing head for dispensing a building material on said fabric;
an imaging system configured to generate an image of said fabric, said image being registered with respect to a lateral system-of-coordinates of said printing system;
a display for displaying a graphical user interface (GUI) showing said image and a graphical representation of an object, said GUI comprises GUI controls for allowing a user to manipulate said graphical representation across said image to align said graphical representation with said image at a GUI location described by said lateral system-of-coordinates; and
a computerized controller configured for controlling said dispensing head to dispense said building material so as to print said object on said fabric at a physical location corresponding to said GUI location.

57. The system according to claim 56, wherein said computerized controller is configured for co-registering a system-of-coordinates of said imaging system with said lateral system-of-coordinates of said printing system.

58. The system according to claim 56, comprising a jig for fixating said fabric to said work tray.

59. The system according to claim 56, wherein said dispensing head is mounted on a tray, and said imaging system is also mounted on said frame.

60. The system according to claim 56, wherein said imaging system is external to said printing system, and wherein said work tray is detachable from said printing system and placeable within said external imaging system.

61. The system according to claim 56, comprising a structure that is in contact with said work tray and that comprises an upper horizontal surface that is elevated above said work tray, said upper horizontal surface being structured to support at least a portion of said fabric.

62. The system according to claim 61, wherein said computerized controller is configured to control said dispensing head to dispense said building material to print said structure on said tray.
